(19) United States
(12) Patent Application Publication
(10) Pub. No.: US 2025/0115767 A1
(43) Pub. Date: Apr. 10, 2025

(54) Methods of Producing Carbon Blacks from Low-Yielding Feedstocks and Products Made from Same

(71) Applicant: Cabot Corporation, Boston, MA (US)

(72) Inventors: David M. Matheu, Somerville, MA (US); Geoffrey D. Moeser, Groton, MA (US); Theis F. Clarke, Houston, TX (US); Thomas E. McElwain, Pampa, TX (US); David S. Crocker, Townsend, TN (US); Akshay Gopan, Somerville, MA (US); Frederick H. Rumpf, Billerica, MA (US); William M. Porteous, N. Andover, MA (US)

(21) Appl. No.: 18/695,525

(22) PCT Filed: Sep. 29, 2022
(86) PCT No.: PCT/US2022/045225

§ 371 Date: Mar. 26, 2024

Related U.S. Application Data
(60) Provisional application No. 63/250,423, filed on Sep. 30, 2021.
(60) Provisional application No. 63/323,341, filed on Mar. 24, 2022.

(51) Int. Cl. C09C 1/50; C09C 1/52

(52) U.S. Cl. CPC C09C 1/50; C09C 1/52

(57) ABSTRACT

Methods to produce carbon black from low-yielding carbon black feedstocks are described. Carbon blacks produced from these carbon black feedstocks are further described. The advantages achieved with the methods are further described.

The present invention relates to methods of producing carbon black produced from alternative carbon black yielding feedstocks, which in many cases can comprise gaseous and/or low-yielding feedstocks. The present invention further relates to carbon blacks formed from alternative carbon black yielding feedstocks that include gaseous and/or low-yielding carbon black feedstocks.

Carbon black has been used to modify the mechanical, electrical, and optical properties in compositions. Carbon blacks and other fillers have been utilized as pigments, fillers, and/or reinforcing agents in the compounding and preparation of compositions used in rubber, plastic, paper or textile applications. The properties of the carbon black or other fillers are important factors in determining various performance characteristics of these compositions. Important uses of elastomeric compositions relate to the manufacture of tires and additional ingredients often are added to impart specific properties to the finished product or its components. Carbon blacks have been used to modify functional properties, electrical conductivity, rheology, surface properties, viscosity, appearances and other properties in elastomeric compositions and other types of compositions.

The conventional and most common process for industrial production of carbon blacks is the furnace process. In this process, a first liquid carbon-bearing feedstock, such as decant oil, is injected into a fuel-lean hot combusted or combusting gas stream. Some of the feedstock pyrolyzes to make carbon black and byproducts (mostly hydrogen): the rest oxidizes to make CO, CO₂, and H₂O. The conventional or traditional feedstock is decant oil, slurry oil, coker oil, a coal tar derivative, or a heavy liquid residue from an ethylene cracker process. These carbon black feedstocks are simultaneously heavy (specific gravity >1.02), have an atomic H:C ratio of at most 1.23, are rich in aromatics (Bureau of Mines Correlation Index (BMCI)≥100), and are liquids at room temperature and pressure (e.g., 25° C. at 1 atm). They are all generally derived from fossil fuels.

The furnace black process differs from the channel black process and thermal black process, both of which use natural gas as a feedstock. The channel black process utilizes thousands of small natural gas diffusion flames to produce small amounts of carbon black. The carbon black is collected on water-cooled metal channels or drums. The channel black process had extremely low yields of approximately 0.05 kg C/kg feed, which lead to its abandonment in the mid-20th century. The thermal black process makes a particular kind of very low-structure carbon black, by passing natural gas feed over previously heated bricks. The natural gas endothermically pyrolyzes to carbon black over the hot bricks: these bricks quickly cool, however, and must be periodically reheated by combustion of byproduct hydrogen and natural gas. The thermal black process makes only niche carbon black grades at very low structure and relatively low yield: it cannot make the great majority of carbon black surface areas and structures needed for the reinforcement of tires, plastics or industrial rubber compounds.

It would be both economically useful and environmentally beneficial to use gaseous, renewable, recycled, and/or sustainable low-yielding feedstocks in an existing carbon black furnace process. These feedstocks would not necessarily be fossil-fuel-based. Examples of these include ethylene, which can be produced from ethane cracking or from bio-ethanol.

Another example is natural gas, which can be fossil-based or produced from landfills or the decay of organic matter. Further examples include vegetable oil, oils derived from the pyrolysis of recycled tires, plastics, municipal waste, or biomass, or natural gas produced from landfills.

Unfortunately, these low-yielding carbon black feedstocks generally give poor yields, low surface areas, and/or low structures in a furnace process, compared to the traditionally used furnace carbon black feedstocks. Performance of these feedstocks in a furnace process can be so poor that it can be impossible to make the structure required for most ASTM grades with them. The maximum achievable structure at a given surface area for a feedstock helps define the grade capability of the feedstock.

Thus, there is a need in the industry to provide a solution to being able to use (to allow the use of) various amounts of low-yielding carbon black-forming feedstocks in an existing carbon black furnace process, and yet produce carbon blacks that are comparable to carbon blacks formed from traditional furnace carbon black feedstocks (e.g., produce carbon blacks with acceptable yields and/or with high surface areas, and/or high structures). It saves large capital and development resources to use an existing furnace process to use these low-yielding feedstocks, instead of developing, designing, and building a new process to use them.

All of the patents and publications mentioned throughout are incorporated in their entirety by reference herein.

### SUMMARY OF THE PRESENT INVENTION

A feature of the present invention is to provide methods to prepare or produce carbon black from feedstocks that include low-yielding carbon black feedstock(s).

A further feature of the present invention is to provide methods to prepare or produce carbon black from feedstocks that include gaseous carbon black feedstocks.

An additional feature of the present invention is to provide carbon blacks made from feedstocks that include low-yielding carbon black feedstocks.

Another feature of the present invention is to provide carbon blacks made from feedstocks that include gaseous carbon black feedstocks.

An additional feature is to provide methods to utilize carbon black feedstocks wherein at least a portion or more of the total amount of feedstock is a low-yielding carbon black feedstock.

A further feature is to provide a method to produce carbon blacks from low-yielding carbon black feedstocks such that the resulting carbon black has acceptable (e.g., good) yield, acceptable (e.g., high) surface area, and/or acceptable structure (e.g., high structure).

To achieve these and other advantages, and in accordance with the purposes of the present invention, as embodied and broadly described herein, the present invention, in part, relates to a method for producing a carbon black. The method includes the step of introducing a heated gas stream into a carbon black reactor (e.g., a furnace carbon black reactor) and combining at least one first carbon black feedstock with the heated gas stream to form a reaction stream. The method further includes the step of combining downstream at least one low-yielding carbon black feedstock to the reaction stream present to form the carbon black. The method further includes recovering the carbon black in the reaction stream. In the method, the at least one low-yielding carbon black feedstock preferably includes at least 10 wt. % of the total feedstock and no more than 90 wt % of the total feedstock (based on total weight). The first carbon black feedstock is preferably a liquid at room temperature and pressure (e.g., 25 deg C. at 1 atm).

In addition, the present invention, in part, relates to a further method for producing a carbon black. The method includes the step of introducing a heated gas stream into a carbon black reactor (e.g., a furnace carbon black reactor) and combining a blend that includes at least one first carbon black feedstock and at least one low-yielding carbon black, with the heated gas stream to form a reaction stream and form the carbon black. The method further includes recovering the carbon black in the reaction stream. In the method, the at least one low-yielding carbon black feedstock preferably includes at least 10 wt. % of the total feedstock and no more than 90 wt % of the total feedstock (based on total weight). The first carbon black feedstock is preferably a liquid at room temperature and pressure (e.g., 25 deg C. at 1 atm).

Further, the present invention, in part, relates to, carbon black(s) where at least 10 wt % of the feedstock used to form the carbon black is at least one low-yielding carbon black feedstock and at least 10 wt % of the feedstock used to form the carbon black is at least one carbon black feedstock.

The present invention further relates to products and/or articles, such as but not limited to, elastomer composites formed from any one or more of the carbon black of the present invention.

It is to be understood that both the foregoing general description and the following detailed description are exemplary and explanatory only and are intended to provide a further explanation of the present invention as claimed.

The accompanying drawings, which are incorporated in and constitute a part of this application, illustrate various features of the present invention and, together with the description, serve to explain the principles of the present invention.

### BRIEF DESCRIPTION OF DRAWINGS

FIG. 1 is a graph displaying the atomic H:C (hydrogen atom to carbon atom) ratio for traditional carbon black feedstocks, compared to the low-yielding feedstocks that are, in part, used in the present invention.

FIG. 2 is a graph showing the specific gravity of traditional carbon black feedstocks, compared to the low-yielding feedstocks that are used, in part, in the present invention.

FIG. 3 is a graph showing the BMCI value for traditional feedstocks, compared to the low-yielding feedstocks that are used, in part, in the present invention.

FIG. 4A is a cross sectional view of one example of a reactor suitable for preparing the carbon black of the present invention.

FIG. 4B is a cross sectional view of another example of a reactor suitable for preparing the carbon black of the present invention.

FIG. 5 is a cross sectional view of a further example of a reactor suitable for preparing the carbon black of the present invention.

FIGS. 6A and 6B show schematic injectors used in some of the comparative examples in side view.

FIGS. 7 and 8 are graphs plotting dimensionless Yield and STSA (in m2/g) for some examples and comparative examples of the present invention. Number labels refer to Example numbers in Tables 6-9.

FIGS. 9 and 10 are graphs plotting OAN and STSA (in m2/g) for some examples and comparative examples of the present invention. Plain number labels refer to Example numbers in Tables 6-9. “N” number labels on open diamond points indicate data for the indicated ASTM grade of carbon black: e.g., point “N330” indicates the surface area and structure typical for N330 grade carbon black.

FIGS. 11, 12, and 13 are graphs plotting OAN and STSA (in m2/g) for some examples and comparative examples of the present invention. Plain number labels refer to Example numbers in Tables 10, 13, and 15.

FIG. 14 is a graph plotting the yield achievable for a given surface area for examples and comparative examples of the present invention. Plain number labels refer to Example numbers in Table 15.

### DETAILED DESCRIPTION OF THE PRESENT INVENTION

The present invention relates to methods for producing carbon blacks that utilize low-yielding carbon black feedstock, as defined and described herein. The present invention further relates to carbon blacks produced from one or more of these methods. With the methods of the present invention, at least a portion of the total carbon black feedstock utilized can be one or more low-yielding carbon black feedstocks. With the methods of the present invention, not only can small to large amounts of low-yielding carbon black feedstocks be used, there is no sacrifice with regard to the quality of carbon black produced. Thus, the methods of the present invention utilize carbon black feedstocks that are more desirable to use for environmental reasons and/or other reasons, and yet produce carbon blacks that are comparable to carbon blacks produced using traditional carbon black feedstocks used in furnace carbon black processes.

A method for producing carbon black of the present invention comprises, consists essentially of, consists of, or includes introducing a heated gas stream into a carbon black reactor (e.g., a furnace carbon black reactor); combining at least one first carbon black feedstock with the heated gas stream to form a reaction stream: combining downstream at least one low-yielding carbon black feedstock to the reaction stream present to form the carbon black, and recovering the carbon black in the reaction stream. In the method, preferably, the at least one low-yielding carbon black feedstock comprises at least 10 wt % of the total feedstock, and can more preferably comprise at least 25 wt. % of the total feedstock.

Another method of the present invention comprises, consists essentially of, consists of, or includes introducing a heated gas stream into a carbon black reactor (e.g., a furnace carbon black reactor); combining a blend that comprises, consists essentially of, consists of, or includes at least one first carbon black feedstock and at least one low-yielding carbon black with the heated gas stream to form a reaction stream to form the carbon black, and recovering the carbon black in the reaction stream. In the method, preferably, the at least one low-yielding carbon black feedstock comprises at least 10 wt % of the total feedstock, and can more preferably comprise at least 25 wt. % of the total feedstock.

For purposes of the present invention, “a low-yielding carbon black feedstock” is a carbon black feedstock having at least one of the following properties:
1) a Bureau of Mines Correlation Index (BMCI)<100 (which provides an indication of low aromatics content for liquid feeds) (e.g., a BMCI of less than 99, of less than 95, of less than 90, of less than 85, of less than 80, of less than 75, of less than 70, such as a BMCI of from 50 to 99 or from 60 to 99, or from 70 to 99, or from 50 to 95 or from 50 to 90), and/or
2) a carbon-containing material that is a gas at room temperature (e.g., 25deg C.) and pressure (1 atm), and/or
3) an atomic H:C ratio of greater than 1.23 (e.g., an H:C ratio of 1.24 or greater, 1.25 or greater, 1.26 or greater, 1.27 or greater, 1.28 or greater, 1.29 or greater, 1.30 or greater, 1.35 or greater, 1.40 or greater, 1.45 or greater, 1.50 or greater, such as from 1.235 to 1.5, or from 1.235 to 1.45, or from 1.235 to 1.4, or from 1.235 to 1.35, or from 1.235 to 1.3 or from 1.235 to 1.29, or from 1.235 to 1.28, or from 1.235 to 1.27 or from 1.24 to 1.5, or from 1.25 to 1.5 or from 1.26 to 1.5 or from 1.27 to 1.5 or form 1.28 to 1.5 or from 1.29 to 1.5 or from 1.3 to 1.5), and/or
4) a specific gravity of at most 1.02 (e.g., at most 1.015, at most 1.01, at most 1.005, at most 1.01, at most 1.00, at most 0.99, at most 0.95, such as from 0.80 to 1.019, or from 0.80 to 1.015, or from 0.80 to 1.01, or from 0.80 to 1.005, or from 0.80 to 1.00, or from 0.80 to 0.95, or from 0.80 to 0.9, or from 0.80 to 1.015, or from 0.90 to 1.01, or from 0.90 to 1.005, or from 1.005 to 1.015).

The low-yielding carbon black feedstock can have the BMCI property only. The low-yielding carbon black feedstock can have the atomic H:C property only. The low-yielding carbon black feedstock can have the specific gravity property only. The low-yielding carbon black feedstock can have the gas property only.

The low-yielding carbon black feedstock can have the BMCI property and the atomic H:C property.

The low-yielding carbon black feedstock can have the BMCI property and the specific gravity property.

The low-yielding carbon black feedstock can have the BMCI property and the gas property.

The low-yielding carbon black feedstock can have the BMCI property, the atomic H:C property, and the specific gravity property.

The low-yielding carbon black feedstock can have the BMCI property, the atomic H:C property, and the gas property.

The low-yielding carbon black feedstock can have the BMCI property, the atomic H:C property, the specific gravity property, and the gas property.

The low-yielding carbon black feedstock can have the atomic H:C property, and the specific gravity property.

The low-yielding carbon black feedstock can have the atomic H:C property, and the gas property.

The low-yielding carbon black feedstock can have the atomic H:C property, the specific gravity property, and the gas property.

The low-yielding carbon black feedstock can have the specific gravity property and the gas property.

A low-yielding carbon black feedstock can be a feedstock derived from what is considered to be sustainable, biological, and/or recycled sources. For example, the low-yielding carbon black feedstock can be or include ethylene, a gas at room temperature and pressure. The ethylene can be produced from bio-sourced ethanol, e.g., from corn fermentation or other plant material fermentations. Another example of a low-yielding carbon black feedstock is natural gas.

The low-yielding carbon black feedstock, for purposes of the present invention, can be a feedstock that is not derived from fossil-fuel-based gasoline production or coal cracking, or cracking to produce olefins. Thus, the low-yielding carbon black feedstock is a feedstock that is other than coal tar liquid, an oil-refinery liquid, or an ethylene cracker residue.

Other examples of low-yielding liquid carbon black feedstocks can include, but are not limited to, the following: a tire pyrolysis oil, a plastic pyrolysis oil, a recycled oil, an algal oil, a plant-derived oil, an oil derived from pyrolysis of municipal solid waste, an oil derived from the pyrolysis or decay of biomass (e.g., animal or vegetable) or agricultural waste, an oil derived from the processing of pulp or paper production byproducts, and/or another oil sourced primarily from biomaterials or any combinations thereof. Exemplary low-yielding feedstocks include but are not limited to a vegetable or other plant-derived oil, a bio-sourced ethanol, a plant- or animal-produced wax or resin, an oil rendered from animal fat, an algal oil, an oil rendered from the pyrolysis of sewage sludge or agricultural waste, a byproduct liquid from processing of a biogenic material, a liquid produced by hydrothermal liquefaction of a biomaterial, a crude tall oil, a tall oil rosin, a tall oil pitch, or a tall oil fatty acid, an oil produced from recycled material, an oil derived from the pyrolysis of off-quality, rejected, or end-of-life tires, an oil derived from the pyrolysis of discarded or recycled plastics or rubber products, an oil derived from the pyrolysis of municipal solid waste, or an oil derived from the pyrolysis of biomass, or any combinations thereof. These liquid feedstocks have an atomic H:C ratio greater than 1.23, or a specific gravity of at most 1.02, or a BMCI value less than 100. Atomic H:C ratio may be measured according to ASTM D5291: specific gravity may be measured by ASTM D4052, BMCI may be measured according to Smith, H. M. (1940). Correlation Index To Aid In Interpreting Crude-Oil Analyses Technical Paper 610. Washington, DC, U.S. Department of the Interior, Bureau of Mines, sulfur content may be measured according to the IP-336 or ISO 8754 standards. Flash point may be measured according to ISO 2719. Specific examples of liquid low-yielding carbon black feedstocks are presented in Table 1 below:

TABLE 1

| Feedstock | Bolder 350 Tire | Delta Energy DE-Solv | Soybean | Corn | Peanut |
|---|---|---|---|---|---|
| Example | Pyrolysis Oil | tire pyrolysis oil | Oil | Oil | Oil |
| Atomic H:C | 1.32 | 1.5 | 1.87 | 1.87 | 1.87 |
| Specific Gravity | 1.00 | 0.94 | 0.93 | 0.92 | 0.91 |
| BMCI | 94 | 62.5 | 56 | 54 | 50 |
| Sulfur Content (wt %) | 1.08 | 1.03 | 0 | 0 | 0 |
| Flash Point (° C.) | 68 | 32 | >110 | 321 | 315 |

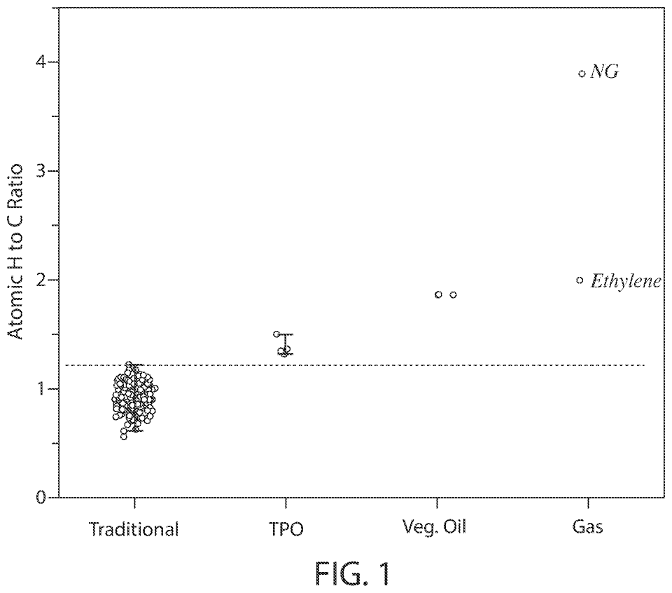

FIG. 1 is a graph that presents the atomic H:C ratio for traditional, high yielding carbon black feedstocks, compared to tire pyrolysis oils (TPO), vegetable oils (Veg. Oil), and two gas-phase feedstocks (natural gas and ethylene) (Gas). For the traditional feedstocks, the H:C is plotted for a collection of approximately 1000 representative coal tar liquids, decant oils, and ECRs used as carbon black feedstocks for the furnace black process, between 2016 and 2021. The H:C value range can be compared with the three low-yielding carbon black feedstock groups. It is clear that traditional feedstocks have a low H:C value≤1.23 (the dashed line of the figure). The low-yielding carbon black feedstocks in FIG. 1, all have an H:C value>1.23.

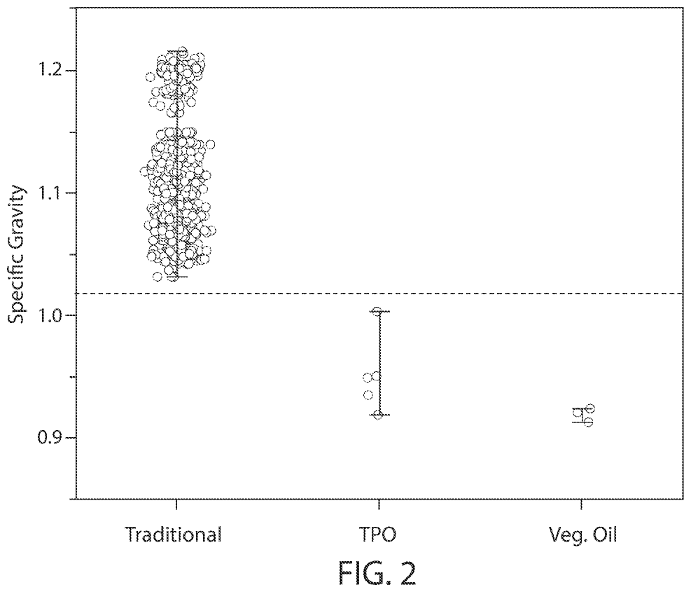

FIG. 2 is a graph that presents examples of specific gravity of traditional, high yielding feedstocks, compared to tire pyrolysis oils (TPO) and vegetable oils (Veg. Oil). For the traditional feedstocks, the specific gravity is plotted for a collection of approximately 1000 representative coal tar liquids, decant oils, and ECRs used as carbon black feedstocks for the furnace black process, between 2016 and 2021. The specific gravity range are compared with two low-yielding carbon black feedstock groups. It is clear that traditional feedstocks generally have a specific gravity greater than 1.02 (the dashed line of the figure), whereas the low-yielding carbon black feedstocks have a specific gravity that is 1.02 or less.

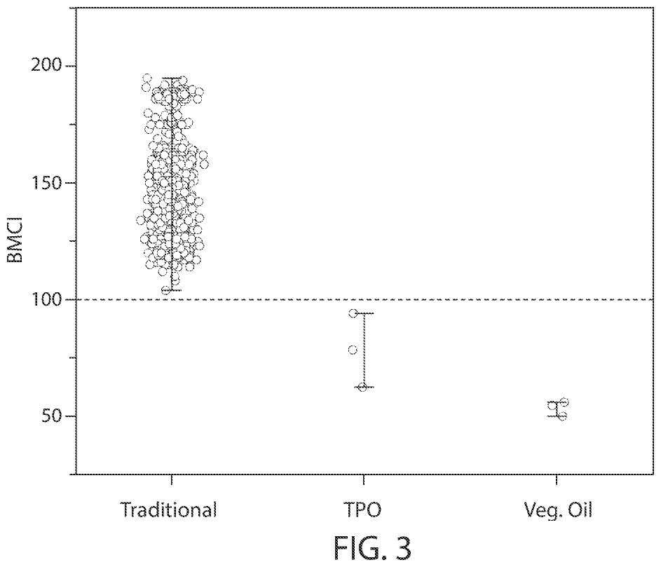

FIG. 3 is a graph that presents examples of BMCI numbers for traditional, high yielding feedstocks, compared to tire pyrolysis oils (TPO) and vegetable oils (Veg. Oil). For the traditional carbon black feedstocks, the BMCI number is plotted for a collection of approximately 1000 representative coal tar liquids, decant oils, and ECRs used as feedstocks for the furnace black process, between 2016 and 2021. Their BMCI values are compared with two low-yielding feedstock groups. Almost all traditional feedstocks have a BMCI value>110, and all examples shown here, have a BMCI number that is greater than or equal to 100 (the dashed line). By contrast, the TPO and vegetable oil groups have a BMCI number of less than 100.

Other examples of low-yielding carbon black feedstocks can include, but are not limited to, the following: a renewable feedstock, a bio-sourced or bio-based feedstock, and/or other byproduct of a refining process, or any combinations thereof.

Other examples of low-yielding carbon black feedstocks can include, but are not limited to, the following: vegetable or other plant-derived oils (e.g., corn oil and/or com distiller's oil).

Other examples of low-yielding carbon black feedstocks can include, but are not limited to, the following: bio-sourced ethanol (from corn fermentation or other plant, vegetable, or fruit sourced fermentation products).

Other examples of low-yielding carbon black feedstocks can include, but are not limited to, the following: plant- or animal-produced waxes and resins, such as lanolin or lac.

Other examples of low-yielding carbon black feedstocks can include, but are not limited to, the following: oils rendered from animal fats.

Other examples of low-yielding carbon black feedstocks can include, but are not limited to, the following: algal oils.

Other examples of low-yielding carbon black feedstocks can include, but are not limited to, the following: oils rendered from the pyrolysis of sewage sludge or agricultural waste.

Other examples of low-yielding carbon black feedstocks can include, but are not limited to, the following: byproduct liquids from processing of biogenic materials.

Other examples of low-yielding carbon black feedstocks can include, but are not limited to, the following: liquids produced by hydrothermal liquefaction of biomaterial.

Other examples of low-yielding carbon black feedstocks can include, but are not limited to, the following: crude tall oils, tall oil rosin, tall oil pitch, or tall oil fatty acids (e.g., from paper making processes).

Other examples of low-yielding carbon black feedstocks can include, but are not limited to, the following: renewable feedstocks such as oils produced from recycled materials.

Other examples of low-yielding carbon black feedstocks can include, but are not limited to, the following: oils derived from the pyrolysis of off-quality, rejected, or end-of-life tires.

Other examples of low-yielding carbon black feedstocks can include, but are not limited to, the following: oils derived from the pyrolysis of discarded or recycled plastics.

Other examples of low-yielding carbon black feedstocks can include, but are not limited to, the following: oils derived from the pyrolysis of municipal solid waste.

Other examples of low-yielding carbon black feedstocks can include, but are not limited to, the following: oils derived from the pyrolysis of biomass (bio oil), e.g., animals or plants (e.g., vegetable).

As indicated above, in the present invention, a portion (by wt %) of the total feedstock utilized in methods of the present invention (either in a staged method or introduced as a blend) is one or more low-yielding carbon black feedstocks, and a portion is not a low-yielding carbon black feedstock. Preferably, the amount of the low-yielding carbon black feedstock (either in a staged method or introduced as a blend) is at least 10 wt %, or at least 15 wt %, or at least 20 wt %, or least 25 wt %, or at least 30 wt %, or at least 35 wt %, or at least 40 wt %, or at least 45 wt %, or at least 50 wt %, or at least 55 wt %, or at least 60 wt %, or at least 65 wt %, or at least 70 wt %, or at least 75 wt %, or at least 80 wt %, or at least 85 wt %, or at least 90 wt % but below 100 wt % and preferably below 99 wt % or below 95 wt %, such as from 10 wt % to 95 wt %, or from 10 wt % to 90 wt %, or from 15 wt % to 90 wt %, or from 20 wt % to 90 wt %, or from 25 wt % to 90 wt %, or from 30 wt % to 90 wt %, or from 35 wt % to 90 wt %, or from 40 wt % to 90 wt %, or from 45 wt % to 90 wt %, or from 50 wt % to 95 wt %, or from 10 wt % to 80 wt %, or from 10 wt % to 70 wt %, or from 10 wt % to 60 wt %, or from 10 wt % to 50 wt %, or from 10 wt % to 40 wt %, or from 10 wt % to 30 wt %, or from 60 wt % to 95 wt %, or from 65 wt % to 95 wt %, or from 70 wt % to 95 wt %, or from 75 wt % to 95 wt %, or from 60 wt % to 95 wt %, or from 60 wt % to 90 wt %, or from 60 wt % to 85 wt %, or from 60 wt % to 80 wt %, or from 60 wt % to 75 wt %, based on total weight percent of all feedstocks used.

For purposes of the present invention, a ‘first carbon black feedstock’ or a ‘high yielding carbon black feedstock’ is a feedstock that is not a low-yielding carbon black feedstock as defined herein. The first carbon black feedstock can be considered or referred to as a carbon black feedstock traditional used in furnace carbon black processes (‘traditional’ carbon black feedstocks). As discussed further herein, the first carbon black feedstock can be a blend of feedstocks that contains, as an option, low amounts of a low-yielding carbon black feedstock.

First carbon black feedstocks are typically from the family of decant or slurry oils, coal tars or coal tar distillate fractions, or ethylene or phenol cracker residues. Their defining characteristics, with respect to carbon black production in a typical furnace process are discussed further below.

A first carbon black feedstock has all three of the following properties:
1) a BMCI of at least 100 (e.g., at least 101, at least 102, at least 103, at least 104, at least 105, at least 110, at least 115, at least 120, at least 130, at least 140, at least 150, at least 160, at least 170, such as from 100 to 180, from 101 to 180, from 102 to 180, from 103 to 180, from 104 to 180, from 105 to 180, from 110 to 180, from 115 to 180, from 120 to 180, from 130 to 180, from 140 to 180, from 150 to 180, from 160 to 180, from 100 to 175, from 100 to 170, from 100 to 165, from 110 to 175, from 115 to 175, from 120 to 175, from 125 to 170, from 130 to 170),
2) a specific gravity of greater than 1.02 (e.g., greater than 1.025, greater than 1.03, greater than 1.035, greater than 1.04, greater than 1.05, such as from 1.021 to 1.3, or from 1.025 to 1.3, or from 1.03 to 1.3, or from 1.05 to 1.3, or from 1.07 to 1.25),
3) an atomic H:C ratio of at most 1.23 (e.g., at most 1.22, at most 1.21, at most 1.2, at most 1.15, at most 1.1, at most 1.05, at most 1, at most 0.9, at most 0.8, such as from 1.225 to 0.7, from 1.225 to 0.8, from 1.225 to 0.9, from 1.225 to 1, from 1.225 to 1.1, from 1.22 to 0.7, from 1.21 to 0.7 from 1.2 to 0.7).

As an option, the first carbon black feedstock may also be a liquid at room temperature and pressure (e.g., 25 deg C. and 1 atm). Despite being a liquid, the first carbon black feedstock may be a pitch or similar material with extremely high viscosity and need not exhibit noticeable flow.

Examples of first carbon black feedstocks are given in Table 2 below, and include coal tars, liquids distilled from coal tars, decant or slurry oils obtained from catalytic cracking, and residue oils from ethylene cracking. As shown in the Table 2, these feedstocks have an H:C of at most 1.23, and a specific gravity greater than 1.02, and a BMCI value of at least 100.

TABLE 2

| | Ethylene | Ethylene | | | | | |
|---|---|---|---|---|---|---|---|
| | Steam | Steam | | | | | |
| Feedstock | Cracker | Cracker | Decant | Decant | Coal Tar | Crude | Decant |
| Example | Residue | Residue | Oil A | Oil B | Distillate | Coal Tar | Oil C |
| Atomic H:C | 0.94 | 0.91 | 0.94 | 1.01 | 0.85 | 0.72 | 1.01 |
| Specific | 1.07 | 1.08 | 1.10 | 1.11 | 1.14 | 1.22 | 1.10 |
| Gravity | | | | | | | |
| BMCI | 127 | 146 | 132 | 134 | 161 | 179 | 163 |
| Sulfur | 0.2 | 0.17 | 2.1 | 0.95 | 0.6 | 0.38 | 1.36 |
| Content | | | | | | | |
| (wt %) | | | | | | | |
| Flash Point | 70 | 86 | 130 | 90 | 90 | | |
| (° C.) | | | | | | | |

The first carbon black feedstock may also comprise a fraction derived from refining or distilling tire pyrolysis oil. Tire pyrolysis may be accomplished by any method known to those of skill in the art. Exemplary methods include but are not limited to those found in U.S. Pat. No. 8,350,105 and US20180320082, the entire contents of both of which are incorporated herein by reference. Distillation of the resulting oil may also be accomplished by any method known to those of skill in the art. Exemplary methods include but are not limited to those found in U.S. Pat. No. 9,920,262, WO2019236214, the contents of which are incorporated herein by reference. The tire pyrolysis oil may be distilled to provide at least one fraction that can be used as a first carbon black feedstock and at least one fraction that is a low yielding carbon black feedstock. Indeed, distillation may result in lightweight fractions that may be more economically employed in other unit processes of the carbon black production process, for example, as fuel for a dryer for the carbon black or for a heater to preheat either or both of the first carbon black feedstock or the second carbon black feedstock as disclosed in US20130039841, the contents of which are incorporated herein by reference. Thus, integration of the distillation process with the carbon black reactor can enable both economic and environmental benefits from the recycling of carbon black filled tires.

As an option, in methods of the present invention, the first carbon black feedstock, based on that total amount of feedstock utilized (by wt %), can be used in amount (either in a staged method or introduced as a blend) of at least 10 wt %, or at least 15 wt %, or at least 20 wt %, or least 25 wt %, or at least 30 wt %, or at least 35 wt %, or at least 40 wt %, or at least 45 wt %, or at least 50 wt %, or at least 55 wt %, or at least 60 wt %, or at least 65 wt %, or at least 70 wt %, or at least 75 wt %, or at least 80 wt %, or at least 85 wt %, or at least 90 wt % but below 100 wt % and preferably below 99 wt % or below 95 wt %, such as from 10 wt % to 95 wt %, or from 10 wt % to 90 wt %, or from 15 wt % to 90 wt %, or from 20 wt % to 90 wt %, or from 25 wt % to 90 wt %, or from 30 wt % to 90 wt %, or from 35 wt % to 90 wt %, or from 40 wt % to 90 wt %, or from 45 wt % to 90 wt %, or from 50 wt % to 95 wt %, or from 10 wt % to 80 wt %, or from 10 wt % to 70 wt %, or from 10 wt % to 60 wt %, or from 10 wt % to 50 wt %, or from 10 wt % to 40 wt %, or from 10 wt % to 30 wt %, or from 60 wt % to 95 wt %, or from 65 wt % to 95 wt %, or from 70 wt % to 95 wt %, or from 75 wt % to 95 wt %, or from 60 wt % to 95 wt %, or from 60 wt % to 90 wt %, or from 60 wt % to 85 wt %, or from 60 wt % to 80 wt %, or from 60 wt % to 75 wt %, based on total weight percent of all feedstocks used. Other amounts of the first carbon black feedstock based on that total amount of feedstock utilized (by wt %), can be 49 wt % or less, 45 wt % or less, 40 wt % or less, 35 wt % or less, 30 wt % or less, 25 wt % or less, 20 wt % or less, 15 wt % or less, 10 wt % or less, 9 wt % or less, 8 wt % or less, 7 wt % or less, 6 wt % or less, such as from 5 wt % to 49 wt % or from 5 wt % to 45 wt %, or from 10 wt % to 40 wt %, or from 10 wt % to 35 wt %, or from 10 wt % to 30 wt %).

The first carbon black feedstock can be a liquid under room temperature (e.g., 25 deg C.) and atmosphere (e.g., 1 atm) conditions. “Rich in aromatic species” means that the feedstock has a high amount of aromatic compounds present. For instance, a high amount of aromatic compounds is where the total weight percent of aromatics present is at least 20 wt % or has a BMCI of at least 100 or both. The first carbon black feedstock can be heated so that the feedstock is in vapor form and thus can become, or be used in practice as, a vapor rich in aromatic species.

With respect to the method steps of the present invention, the method includes the step of forming or introducing a heated gas stream into a carbon black reactor (e.g., a furnace carbon black reactor).

The ‘heated gas stream’ can be a stream of hot gases or hot combustion gases. The heated gas stream can be generated by contacting a solid, liquid, and/or gaseous fuel with a suitable oxidant stream such as, but not limited to, air, oxygen, mixtures of air and oxygen, or the like. Alternatively, a preheated oxidant stream may be passed through without adding a liquid or gaseous fuel. Examples of the fuel suitable for use in contacting the oxidant stream to generate the hot gases include any of the readily combustible gas, vapor, or liquid streams, such as natural gas, hydrogen, carbon monoxide, methane, acetylene, alcohol, or kerosene. Generally, it is preferred to use fuels having a high content of carbon-containing components and in particular, hydrocarbons. The equivalence ratio (defined below) for the mixture of fuel and oxidizer mixed to form the hot gas can be from 10 (very fuel-rich) to about 0.1 (very fuel-lean), or the lowest value that still permits generation of the hot gas using a given combustor or oxidizing device. As stated, to facilitate the generation of hot gases, the oxidant stream may be preheated. Essentially, the heated gas stream is created by igniting or combusting the fuel and/or oxidant. Temperatures such as from about 1000 deg C. to about 3500 deg C. for the heated gas stream can be obtained.

The carbon black reactor is preferably a furnace carbon black reactor. More preferably, the carbon black reactor is a version of the furnace reactor called a staged carbon black reactor (e.g., multi-stage carbon black reactor or multi-stage reactor). “Staged” means that feedstock is introduced or injected at more than one axial location along the long axis of the furnace.

For purposes of this method as well as the other methods described herein, a multi-stage carbon black reactor can be used such as the ones described in U.S. Pat. Nos. 4,383,973, 7,829,057, 5,190,739, 5,877,251, 6,153,684, or 6,403,695, all of which are incorporated in their entirety by reference herein.

The general process of forming carbon black through the carbon black reactor, such as a multi-stage reactor, and achieving appropriate hot gases to form carbon black are further described in the above-identified referenced patents which are incorporated by reference herein and can be applied in the present invention with the changes described herein.

Specific examples or embodiments of the present invention include where the low-yielding carbon black feedstock comprises, consists of, or only is a pyrolysis oil and this is combined, as described herein, with at least one first carbon black feedstock. For purposes of the present invention, the pyrolysis oil can be used as a blend with the first carbon black feedstock and/or can be introduced in a staged manner (e.g., where the first carbon black feedstock is introduced first, and then the pyrolysis oil is then introduced into the heated gas stream). Whether in a blend or a staged manner, the pyrolysis oil can comprise from 10 wt % to 90 wt % of the total carbon black feedstock utilized in the process, and the first carbon black feedstock comprises from 10 wt % to 90 wt % of the total carbon black feedstock utilized in the process. The various weight percent ranges for the first carbon black feedstock and low-yielding carbon black described earlier can apply equally here.

Specific examples or embodiments of the present invention also include where the low-yielding carbon black feedstock comprises, consists of, or only is an ethylene and/or natural gas and this is combined, as described herein, with at least one first carbon black feedstock. For purposes of the present invention, the ethylene and/or natural gas can be used as a blend with the first carbon black feedstock and/or can be introduced in a staged manner (e.g., where the first carbon black feedstock is introduced first, and then the ethylene and/or natural gas is then introduced into the heated gas stream). Whether in a blend or a staged manner, the ethylene and/or natural gas can comprise from 10 wt % to 90 wt % of the total carbon black feedstock utilized in the process, and the first carbon black feedstock comprises from 10 wt % to 90 wt % of the total carbon black feedstock utilized in the process. A preferred option is where the ethylene and/or natural gas comprises from 30 wt % to 90 wt % of the total carbon black feedstock utilized in the process, and the first carbon black feedstock comprises from 10 wt % to 70 wt % of the total carbon black feedstock utilized in the process. The various weight percent ranges for the first carbon black feedstock and low-yielding carbon black described earlier can apply equally here.

Specific examples or embodiments of the present invention further include where the low-yielding carbon black feedstock comprises, consists of, or only is a bio-based carbon black feedstock (e.g., biogas, rapeseed oil, soya oil, palm oil, sunflower oil, oil(s) derived from nuts and/or olive oil and/or other plant and/or tree oils) and this is combined, as described herein, with at least one first carbon black feedstock. For purposes of the present invention, the bio-based (or bio-sourced) carbon black feedstock can be used as a blend with the first carbon black feedstock and/or can be introduced in a staged manner (e.g., where the first carbon black feedstock is introduced first, and then the bio-based carbon black feedstock is then introduced into the heated gas stream). Whether in a blend or a staged manner, the bio-based carbon black feedstock can comprise from 10 wt % to 90 wt % of the total carbon black feedstock utilized in the process, and the first carbon black feedstock comprises from 10 wt % to 90 wt % of the total carbon black feedstock utilized in the process. A preferred option is where the bio-based carbon black feedstock comprises from 30 wt % to 90 wt % of the total carbon black feedstock utilized in the process, and the first carbon black feedstock comprises from 10 wt % to 70 wt %. The various weight percent ranges for the first carbon black feedstock and low-yielding carbon black described earlier can apply equally here.

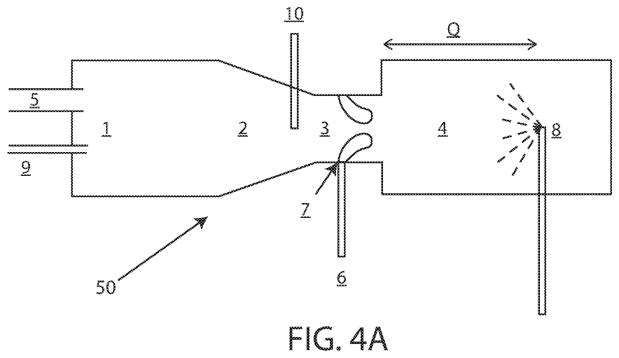

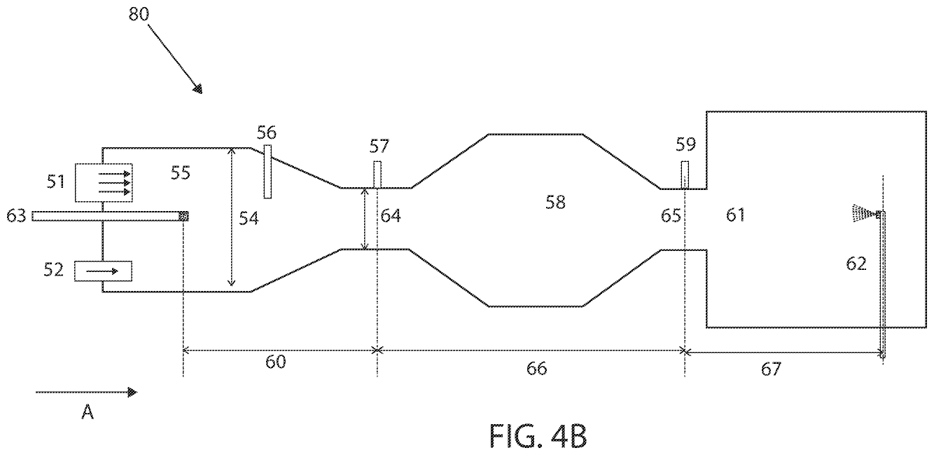

FIGS. 4A and 4B show a cross-sectional view of a carbon black reactor (50 in FIG. 4A and 80 in FIG. 4B) that can be used. In FIG. 4A, hot combustion gases are generated in a combustion zone or combustion chamber 1 by contacting fuel in the form of a liquid or gaseous fuel steam 9 with an oxidant stream 5, for example air, oxygen, or mixtures of air and oxygen (also known in the art as “oxygen-enriched air”). The fuel can be any readily combustible gas, vapor, or liquid streams such as hydrocarbons (e.g., methane, natural gas, acetylene), hydrogen, alcohols, kerosene, fuel mixtures and so forth. In many cases, the fuel selected has a high content of carbon-containing components.

Various gaseous or liquid fuels, e.g., hydrocarbons, may be used as the combustion fuel. The equivalence ratio is a ratio of fuel to the amount of oxidant stoichiometrically required to completely combust the fuel. Typical values for the equivalence ratio in the combustion zone range from 1.2 to 0.2. To facilitate the generation of hot combustion gases, the oxidant stream may be pre-heated.

In the present invention, the combustion step can completely or almost completely consume the combustion fuel. Oxygen, fuel selection, burner design, jet velocities, mixing conditions and/or patterns, ratios of fuel to air, oxygen enriched air or pure oxygen, temperatures, and/or other factors can be adjusted or optimized.

The hot combustion gas stream flows downstream from zones 1 and 2 into zones 3 and 4. The carbon black feedstocks are introduced at one or more suitable locations relative to other reactor components and feeds. Zone 2 of the combustion chamber can be the location where one or more carbon black feedstocks are introduced. In FIG. 4A, an injector 10 and/or injector 6 can be used to introduce carbon black feedstock into the reactor. Injector 10, for instance, can introduce or inject a first carbon black feedstock into the reactor. As an alternative, the first carbon black feedstock may also be introduced into the chamber using an axial pipe or lance (shown as pipe or lance 63 in FIG. 4B). As a further alternative, the first carbon black feedstock may be injected or introduced by multiple methods simultaneously. The lance or any other injector exposed to the reactor or combustion chamber may need to be cooled or protected from excessive heat in the combustion chamber, by methods known in the art.

A further carbon black feedstock, e.g., a low-yielding carbon black feedstock, can be introduced to reactor zone 3 at injection point 7 by injector 6. In the present invention, generally, at least a portion if not all of the first carbon black feedstock can be injected or introduced prior to introducing the low-yielding carbon black feedstock into the reactor. Preferably, a majority (>50%) of the first carbon black feedstock used in the reactor is introduced prior to introducing any low-yielding carbon black feedstock. Zones 3 and 4 are reaction zones and zone 8 is the quench zone. Q represents the length of zone 4 prior to the quench zone 8.

The carbon black feedstocks can be injected into the combustion gas stream through one or more nozzles designed for optimal distribution of the feedstock into the combustion gas stream. Such nozzles may be either single or bi-fluid. Bi-fluid nozzles may use, for example, steam, air, or nitrogen to atomize the feedstock. Single-fluid nozzles may be pressure atomized or the feedstock can be directly injected into the gas-stream. In the latter instance, atomization occurs by the force of the gas-stream.

The carbon black feedstock may be injected by an axial injection lance or a central pipe can be used and/or one or more radial lances arranged on the circumference of the reactor in a plane perpendicular to the flow direction. A reactor may contain several planes with radial lances along the flow direction. Spray or injection nozzles can be arranged on the head of the lances by means of which the feedstock is mixed into the flow of the heated gas stream.

FIG. 4B illustrates a cross section of another example of a carbon black reactor in the furnace process, which can be used in the present invention. In this example, as in FIG. 4A, an oxidant stream 51 is combined in a combustion chamber 55 with a combustion fuel 52.

The hot combusted or partially combusted gas stream prepared in the chamber 55 flows in direction A toward a throat or contraction 64. The first carbon black feedstock is introduced to the furnace carbon black reactor 80, prior to the low-yielding carbon black feedstock. The first carbon black feedstock can be introduced using an optional central pipe 63, or a lance or injector or set of lances 56, or via lances or injectors placed at or near the throat 64 as indicated by 57. The first carbon black feedstock can be introduced at one of these locations, or simultaneously in two of these locations at the same time, or in all three locations simultaneously. The manner and division of the first feedstock injection, when more than one location is used, among these locations can be varied to modify product properties and process economics. Injectors as well as the combustion chamber itself (or portions thereof), may be cooled as needed by methods known in the art.

In FIG. 4B, the length between the optional central pipe injector 63, and the middle of the contraction 64, is labeled as length 60. If this central pipe is used, this length is preferably from 1× (times) to 10× the narrowest diameter of the first contraction 64. If the central pipe is used simultaneously with an injector or lance array 57 for the introduction of the first carbon black feedstock, then length 60 can be as stated above or may be as small as 0. Adjusting this length may allow balancing of structure and process economics. Height or diameter 54 is shown for the combustion chamber and this height is more than the height or diameter 64 and the height or diameter 64 can be at least 20%, at least 30%, at least 40%, at least 50% smaller than height or diameter 54.

Following the introduction of the first carbon black feedstock, the hot gas stream mixed with the feedstock enters a first reaction chamber 58. The purpose of the chamber is to provide residence time so that pyrolysis reactions that produce carbon black may complete an induction time and begin, and optionally, to produce a seed particle population for later structure growth as taught in U.S. Pat. No. 7,829,057. The length of this chamber 66 can be typically from 1× to 20× the narrowest diameter of the first contraction 64.

At the end of the first reaction chamber 58, the low-yielding carbon black feedstock can be introduced. It may be introduced using an injector or injector array 59 positioned within or near a second contraction 65. Alternatively, it may be introduced with a lance substantially upstream of contraction 65, but within chamber 58.

After introduction of the low-yielding carbon black feedstock, the mixture flows into a second reaction chamber 61. It is then quenched using a cooling spray of liquid or vapor 62, as is known in the art. The length from the low-yielding carbon black feedstock's injection point 59 to quench location 62 is labeled as 67 in FIG. 4B. This length is set to provide a residence time that controls certain product properties as is known in the art of the furnace process.

An alternative arrangement introduces the first carbon black feedstock at locations 63 and/or 56, and then introduces the low-yielding carbon black feedstock at locations 57 and/or 59, which can be simultaneously if both locations are used. This can offer a beneficial tradeoff between carbon black structure capability and yield or process economics. In all the above embodiments, at least a portion, and preferably the majority (>50%) of the first carbon black feedstock that is used, for example, all of the first carbon black feedstock, is introduced before and upstream of the low-yielding carbon black feedstock.

In yet another example of the present invention, the first carbon black feedstock may be a blend of a high yielding carbon black feedstock satisfying the BMCI, specific gravity, and H:C parameters described above and a low-yielding carbon black feedstock, provided the blend satisfies the BMCI, specific gravity, and H:C parameters described above for the first carbon black feedstock. The blend may contain more than 50 wt % of the high yielding carbon black feedstock by mass (e.g., 50.5 wt % to 99.5 wt % of the high yielding carbon black feedstock, such as from 60 wt % to 99 wt %). Similarly, the low-yielding carbon black feedstock can optionally be a blend of a high yielding carbon black feedstock and a non-high yielding carbon black feedstock that fails to satisfy at least one of the BMCI, H:C, and specific gravity parameters required for the first carbon black feedstock, provided that the blend also fails to satisfy at least one of the BMCI, H:C, and specific gravity parameters required for the first carbon black feedstock. The non-high yielding carbon black feedstock may be present in an amount of more than 50% of the total feedstock of this optional blend, by mass (e.g., 50.5 wt % to 99.5 wt % of the non-high yielding carbon black feedstock such as from 60 wt % to 99 wt %). Additionally, the total amount of first carbon black feedstock introduced to the reactor through the sum of all injection locations is less than 50 wt % based on the total amount of carbon black feedstock used anywhere in the reactor. The total amount of low-yielding carbon black feedstock is greater than 50 wt % based on total feedstock.

As an option, in one method of the present invention, the method includes the step of introducing at least one first carbon black feedstock with the heated gas stream, in the carbon black reactor, to form a reaction stream. The first carbon black feedstock can be one or a combination of two or more different first carbon black feedstocks. When more than one type of feedstock is utilized as the first carbon black feedstock, the multiple first carbon black feedstocks can be blended together and injected as one blended feedstock through one or multiple locations, or each feedstock can be separately injected into the combustion chamber at the same or different locations.

As an option, in one method of the present invention, the method includes the step of introducing at least one low-yielding carbon black feedstock into a reaction stream. The low-yielding carbon black feedstock can be one or a combination of two or more different low-yielding carbon black feedstocks. When more than one type of feedstock is utilized as the low-yielding carbon black feedstock, the multiple low-yielding carbon black feedstocks can be blended together and injected as one blended feedstock through one or multiple locations, or each feedstock can be separately injected into the combustion chamber at the same or different locations.

Generally, any of the carbon black feedstocks that are utilized in any of the methods of the present invention can be injected into a reactor by a single stream or a plurality of streams using injectors, which penetrate into the interior regions of the hot combustion gas stream. An injector can better ensure a high rate of mixing and shearing of the hot combustion gases and the carbon black feedstock(s). This ensures that the feedstock pyrolyzes and preferably at a rapid rate and/or high yield to form the carbon black of the present invention.

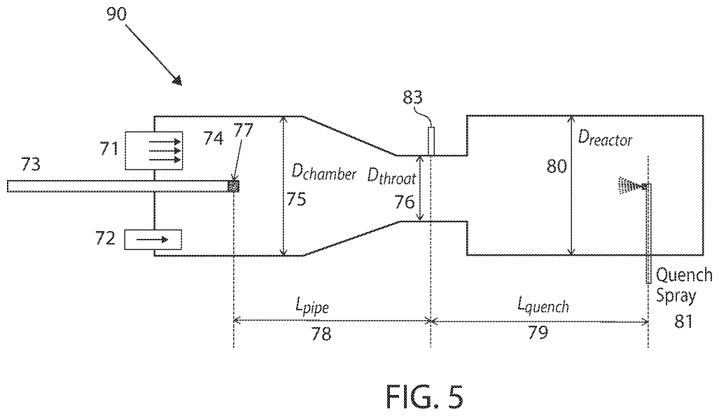

FIG. 5 illustrates a specific example of a reactor that may be used to practice the invention, and was used to produce the Examples 1-13 described below.

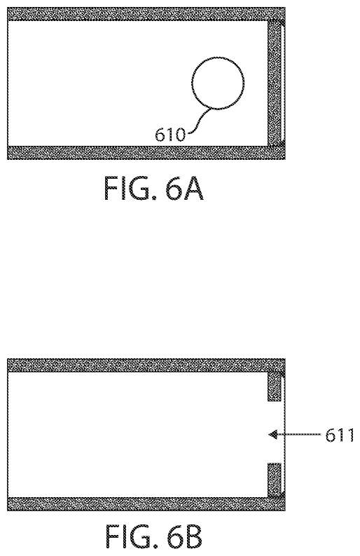

The first carbon black feedstock can be introduced at one location in the reactor or at multiple locations in the reactor. The introducing of this feedstock can be done with a central pipe or lance 73 located in the combustion chamber 74 having a largest diameter Dchamber 75, in the reactor 90 as, for instance, shown in FIG. 5. The central pipe can be positioned approximately on the centerline of the reactor (axial center). The central pipe can have an injector head 77 or spray head on the tip. The injector on the tip can have, for instance, one or multiple holes (2 or 3 or 4 or more) around the tip (e.g., generally evenly spaced multiple holes as shown in FIG. 6A, where one of multiple holes 610 is shown). This injection point can be done with a central pipe or can be achieved using other injection devices.

In one embodiment of the present invention, the low-yielding carbon black feedstock can be introduced at one location in the reactor or at multiple locations in the reactor. As indicated, in this method of the present invention, the location or locations in the reactor are downstream of the location/locations of where the first carbon black feedstock is injected or introduced. The introducing of the low-yielding carbon black feedstock can be done with one or more injectors (e.g., a metal pipe(s) located on the wall of the reactor) which introduce the feedstock in the combustion chamber of the reactor, as for instance, shown in FIGS. 4A and 4B. The injector can have an injector head or spray head on the tip. The injector on the tip can have, for instance, one or multiple holes (2 or 3 or 4 or more) around the tip (generally evenly spaced multiple holes).

As an option, the introduction of the low-yielding carbon black feedstock into the reactor and into the reaction stream can be such that the feedstock is introduced perpendicular to the lateral flow of the reaction stream through the reactor, as for instance shown in FIGS. 4A and 4B. Perpendicular can be plus or minus 15 degrees from a true perpendicular injection of the feedstock into the reaction stream.

As an option, the introduction of the low-yielding carbon black feedstock into the reactor can be at a location that has a narrower diameter than a diameter of the reactor where the first carbon black feedstock was earlier introduced. This location can be considered a ‘throat’ in some carbon black reactors. FIGS. 4A and 4B provide an example of this throat or throat area in a reactor. This narrower diameter can have a diameter that is at least 10% smaller, at least 20% smaller, or at least 30% smaller, or from 10% to 40% smaller than the diameter of the reactor where the first carbon black feedstock was earlier introduced. In FIG. 5, this is Dchamber 75 vs. Dthroat 76.

As an option, the introduction of the low-yielding carbon black feedstock into the reactor and into the reaction stream can be at a location that is a distance DA (in FIG. 5, this distance is indicated as Lpipe, 78) from where the first carbon black feedstock is introduced or injected in the reactor, and this DA is at least 1 or at least 2 times the narrowest diameter of the combustion chamber of the reactor (or is at least 2 times the diameter of the reactor where the first carbon black feedstock was introduced or injected). This distance can be at least 2.25, at least 2.5, at least 2.75, at least 3, at least 3.25, at least 3.5, at least 3.75, or at least 4 times the diameter of the combustion chamber of the reactor (or is at least 2.25, at least 2.5, at least 2.75, at least 3, at least 3.25, at least 3.5, at least 3.75, or at least 4 times the diameter of the reactor where the first carbon black was introduced or injected).

The low-yielding carbon black feedstock can be introduced at location 83 through one or more injectors.

After the feedstocks (first carbon black feedstock and low-yielding carbon black feedstock) are combined with the reaction stream, the methods of the present invention generally include the step of quenching the reaction. In FIG. 5 this is Quench spray 81. The reaction zone, after throat 76 is shown as 80 have a largest diameter of Dreactor. Lquench shows the length from where the low-yielding carbon black feedstock is introduced to where quenching occurs.

The reaction is arrested in the quench zone of the reactor (see zone 8 of FIG. 4A). As shown in FIG. 4A, quench 8 is located downstream of the reaction zone 4 and sprays a quenching fluid, such as water, into the stream of newly formed carbon black particles. In general, the quench serves to cool the carbon black particles and to reduce the temperature of the gaseous stream and decrease the reaction rate. Q is the distance from the beginning of reaction zone 4 to quench point 8, and will vary according to the position of the quench. Optionally, quenching may be staged, or take place at several points in the reactor. A pressure spray, a gas-atomized spray or other quenching techniques also can be utilized. With respect to completely quenching the reactions to form the carbon black, any means known to those skilled in the art to quench the reaction downstream of the introduction of the carbon black yielding feedstocks can be used. For instance, a quenching fluid, which may be water or other suitable fluids, can be injected to stop the chemical reaction.

After quenching, the cooled gases and carbon black pass downstream into any conventional cooling and separating means whereby the product is recovered. The separation of the carbon black from the gas stream is readily accomplished by conventional means such as a precipitator, cyclone separator, bag filter or other means known to those skilled in the art. After the carbon black is separated from the gas stream, the carbon black can be optionally subjected to a pelletization step.

For any of the methods of the present invention, as an option, the carbon black produced is not a carbon black with a core and a coating.

For any of the methods of the present invention, as an option, the carbon black is entirely formed in-situ in the reactor.

As an option, any one or more of the carbon black feedstocks or other components used in the methods of the present invention can be pre-heated prior to introduction into the reactor. Suitable pre-heating temperatures and/or pre-heating techniques can be used in the present invention as set forth in, for example, in U.S. Pat. No. 3,095,273 issued on Jun. 25, 1963 to Austin; U.S. Pat. No. 3,288,696 issued on Nov. 29, 1966 to Orbach; U.S. Pat. No. 3,984,528 issued on Oct. 5, 1976 to Cheng et al.: U.S. Pat. No. 4,315,901, issued on Feb. 16, 1982 to Cheng et al.: U.S. Pat. No. 4,765,964 issued on Aug. 23, 1988 to Gravley et al.: U.S. Pat. No. 5,997,837 issued on Dec. 7, 1999 to Lynum et al. U.S. Pat. No. 7,097,822 issued on Aug. 29, 2006 to Godal et al.: U.S. Pat. No. 8,871,173B2, issued on Oct. 28, 2014 to Nester et al. or CA 682982, all documents being incorporated herein by reference in their entirety. Alternatively or in addition, the low yielding carbon black feedstock may be pre-heated to a higher temperature than is typical for a higher yielding feedstock. For example, the low yielding carbon black feedstock may be heated to a temperature in excess of 600 deg C., for example, 600-800 deg C., even at ambient pressure. Because the low yielding carbon black feedstock has a low concentration of asphaltenes, heating to such a high temperature does not generate significant amounts of coke or other solid non-carbon black species. Alternatively or in addition, any one or more of the carbon black feedstocks may be combined with an extender fluid prior to introduction into the reactor, for example, as described in U.S. Pat. No. 10,829,642 to Unrau, the entire contents of which are incorporated herein by reference.

As an option, the method is conducted in the absence of at least one substance that is or that contains at least one Group IA or Group IIA element (or ion thereof) of the Periodic Table.

As an option, in any of the methods of the present invention, the method can include the step of introducing at least one substance that is or that contains at least one Group IA or Group IIA element (or ion thereof) of the Periodic Table. Preferably, the substance contains at least one alkali metal or alkaline earth metal. Examples include lithium, sodium, potassium, rubidium, cesium, francium, calcium, barium, strontium, or radium, or combinations thereof. Any mixtures of one or more of these components can be present in the substance. The substance can be a solid, solution, dispersion, gas, or any combinations thereof. More than one substance having the same or different Group IA or Group IIA metal can be used. If multiple substances are used, the substances can be added together, separately, sequentially, or in different reaction locations. For purposes of the present invention, the substance can be the metal (or metal ion) itself, a compound containing one or more of these elements, including a salt containing one or more of these elements, and the like. Preferably, the substance is capable of introducing a metal or metal ion into the reaction that is ongoing to form the carbon black product. For purposes of the present invention, preferably, the substance is introduced prior to the complete quenching as described above. For instance, the substance can be added at any point prior to the complete quenching, including prior to the introduction of one or both of the carbon black yielding feedstocks: during the introduction of any one or both of the carbon black yielding feedstocks: after the introduction of any or all of the carbon black yielding feedstocks: or after the introduction of the all of the feedstocks but prior to the complete quenching. More than one point of introduction of the substance can be used. The amount of the Group IA or Group IIA metal containing substance can be any amount as long as a carbon black product can be formed. For instance, the amount of the substance can be added in an amount such that 200 ppm or more of the Group IA or Group IIA element is present in the carbon black product ultimately formed. Other amounts include from about 200 ppm to about 5000 ppm or more and other ranges can be from about 300 ppm to about 1000 ppm, or from about 500 ppm to about 1000 ppm of the Group IA or Group IIA element present in the carbon black product that is formed. These levels can be with respect to the metal ion concentration. As stated, these amounts of the Group IA or Group IIA element present in the carbon black product that is formed can be with respect to one element or more than one Group IA or Group IIA element and would be therefore a combined amount of the Group IA or Group IIA elements present in the carbon black product that is formed. The substance can be added in any fashion including any conventional means. In other words, the substance can be added in the same manner that a carbon black yielding feedstock is introduced. The substance can be added as a gas, liquid, or solid, or any combination thereof. The substance can be added at one point or several points and can be added as a single stream or a plurality of streams. The substance can be mixed in with the feedstock, fuel, and/or oxidant prior to or during their introduction.

With respect to the carbon black formed by any of the methods of the present invention, the carbon black formed or produced can be any reinforcing or non-reinforcing grade of carbon black. Examples of reinforcing grades are N110, N121, N220, N231, N234, N299, N326, N330, N339, N347, N351, N358, and N375. Examples of semi-reinforcing grades are N539, N550, N650, N660, N683, N762, N765, N774, N787, and/or N990.

The carbon black can be a furnace black.

The carbon black can be characterized by specific surface area, structure, aggregate size, shape, and distribution; and/or chemical and physical properties of the surface. The properties of carbon black are analytically determined by tests known to the art. For example, nitrogen adsorption surface area and Statistical Thickness Surface Area (STSA), another measure of surface area, are determined by nitrogen adsorption following ASTM test procedure D6556. The Iodine number can be measured using ASTM procedure D-1510. Carbon black “structure” describes the size and complexity of aggregates of carbon black formed by the fusion of primary carbon black particles to one another. As used here, the carbon black structure can be measured as the oil absorption number (OAN) for the uncrushed carbon black, expressed as milliliters of oil per 100 grams carbon black, according to the procedure set forth in ASTM D-2414. The Compressed Sample Oil absorption number (COAN) measures that portion of the carbon black structure which is not easily altered by application of mechanical stress. COAN is measured according to ATSM D3493. Aggregate size distribution (ASD) is measured according to ISO 15825 method using Disc Centrifuge Photosedimentometry with a model BI-DCP manufactured by Brookhaven Instruments.

Carbon black materials having suitable properties for a specific application may be selected and defined by the ASTM standards (see, e.g., ASTM D 1765 Standard Classification System for Carbon Blacks Used in Rubber Products), e.g., N100, N200, N300, N500, N600, N700, N800, or N900 series carbon blacks, for example, N110, N121, N220, N231, N234, N299, N326, N330, N339, N347, N351, N358, N375, N539, N550, N650, N660, N683, N762, N765, N774, N787, or N990 carbon blacks, or other commercial grade specifications.

The carbon black can have any STSA such as ranging from 5 m²/g to 250 m2/g, 11 m2/g to 250 m2/g, 20 m2/g to 250 m2/g or higher, for instance, at least 70 m2/g, such as from 70 m2/g to 250 m2/g, or 80 m2/g to 200 m²/g or from 90 m2/g to 200 m²/g, or from 100 m²/g to 180 m2/g, from 110 m²/g to 150 m2/g, from 120 m2/g to 150 m2/g and the like. As an option, the carbon black can have an Iodine Number (12 No) of from about 5 to about 35 mg 12/g carbon black (per ASTM D1510).

The carbon black particles disclosed herein can have a BET surface area, measured by Brunauer/Emmett/Teller (BET) technique according to the procedure of ASTM D6556, from 5 m²/g to 300 m²/g, for instance between 50 m2/g and 300 m²/g, e.g., between 100 m²/g and 300 m²/g. The BET surface area can be from about 100 m²/g to about 200 m²/g or from about 200 m²/g to about 300 m²/g.

The oil adsorption number (OAN) can be from 40 mL/100 g to 200 mL/100 g, for instance between 60 mL/100 g and 200 mL/100 g, such as between 80 mL/100 g and 200 mL/100 g, e.g., between 100 mL/100 g and 200 mL/100 g or between 120 mL/100 g and 200 mL/100 g, between 140 mL/100 g and 200 mL/100 g mL/100 g, between 160 and 200 mL/100 g or such as between 40 mL/100 g and 150 mL/100 g or 40 mL/100 g and 150 mL/100 g.

The COAN can be within the range of from about 40 mL/100 g to about 150 mL/100 g, e.g., between about 55 mL/100 g to about 150 mL/100 g, such as between about 80 mL/100 g to about 150 mL/100 g, or between about 80 mL/100 g to about 120 mL/100 g.

The carbon black can be a carbon product containing silicon-containing species and/or metal containing species and the like, which can be achieved by including the further step of introducing such a species with or in addition to either or both of the carbon black-yielding feedstocks. The carbon black can be for purposes of the present invention, a multi-phase aggregate comprising at least one carbon phase and at least one metal-containing species phase or silicon-containing species phase (also known as silicon-treated carbon black, such as ECOBLAK™ materials from Cabot Corporation).

As stated, the carbon black can be a rubber black, and especially a reinforcing grade of carbon black or a semi-reinforcing grade of carbon black.

As an option, the carbon black of the present invention can have functional groups or chemical groups (e.g., derived from small molecules or polymers, either ionic or nonionic) that are directly attached to the carbon surface (e.g., covalently attached). Examples of functional groups that can be directly attached (e.g., covalently) to the surface of the carbon black particles and methods for carrying out the surface modification are described, for example, in U.S. Pat. No. 5,554,739 issued to Belmont on Sep. 10, 1996 and U.S. Pat. No. 5,922,118 to Johnson et al. on Jul. 13, 1999, incorporated herein by reference in their entirety. As one illustration, a surface modified carbon black that can be employed here is obtained by treating carbon black with diazonium salts formed by the reaction of either sulfanilic acid or para-amino-benzoic acid (PABA) with HCl and NaNO₂. Surface modification by sulfanilic or para-amino-benzoic acid processes using diazonium salts, for example, results in carbon black having effective amounts of hydrophilic moieties on the carbon coating.

The carbon black can be surface modified according to U.S. Pat. No. 8,975,316 to Belmont et al., the contents of which are incorporated herein by reference in their entirety.

Other techniques that can be used to provide functional groups attached to the surface of the carbon black are described in U.S. Pat. No. 7,300,964, issued to Niedermeier et al, on Nov. 27, 2007.

Oxidized (modified) carbon black can be prepared in a manner similar to that used on carbon black, as described, for example, in U.S. Pat. No. 7,922,805 issued to Kowalski et al. on Apr. 12, 2011, and in U.S. Pat. No. 6,471,763 issued to Karl on Oct. 29, 2002, and incorporated herein by reference in their entirety. An oxidized carbon black is one that that has been oxidized using an oxidizing agent in order to introduce ionic and/or ionizable groups onto the surface. Such particles may have a higher degree of oxygen-containing groups on the surface. Oxidizing agents include, but are not limited to, oxygen gas, ozone, peroxides such as hydrogen peroxide, persulfates, including sodium and potassium persulfate, hypohalites such a sodium hypochlorite, oxidizing acids such a nitric acid, and transition metal containing oxidants, such as permanganate salts, osmium tetroxide, chromium oxides, or ceric ammonium nitrate. Mixtures of oxidants may also be used, particularly mixtures of gaseous oxidants such as oxygen and ozone. Other surface modification methods, such as chlorination and sulfonylation, may also be employed to introduce ionic or ionizable groups. The carbon black may be surface modified by any method known to those of skill in the art. For example, the carbon black may be heat treated as described in U.S. Pat. No. 10,767,028, the entire contents of which are incorporated herein by reference.

The carbon black can be utilized in various applications, such as, for example, as reinforcement in rubber products, e.g., tire components.

The carbon black can be incorporated in rubber articles, being used, for instance, for tire tread, especially in tread for passenger car, light vehicle, truck and bus tires, off-the-road (“OTR”) tires, airplane tires and the like; sub-tread; wire skim; sidewalls; cushion gum for retread tires; and other tire uses.

In other applications, the particles can be used in industrial rubber articles, such as engine mounts, hydro-mounts, bridge bearings and seismic isolators, tank tracks or tread, mining belts, hoses, gaskets, seals, blades, weather stripping articles, bumpers, anti-vibration parts, and others.

The carbon black can be added as an alternative or in addition to first reinforcing agents for tire components and/or other industrial rubber end-uses. The carbon black can be combined with natural and/or synthetic rubber in a suitable dry or wet mixing process based on an internal batch mixer, continuous mixer or roll mill.

Alternatively, the carbon black may be mixed into rubber via a liquid masterbatch process. For instance, a slurry containing the particles described herein also can be combined with elastomer latex in a vat and then coagulated by the addition of a coagulant, such as an acid, using the techniques described in U.S. Pat. No. 6,841,606.

The carbon black can be introduced according to U.S. Pat. No. 6,048,923, issued to Mabry et al. on Apr. 11, 2000, incorporated herein by reference in its entirety. For example, a method for preparing elastomer masterbatch can involve feeding simultaneously a particulate filler fluid and an elastomer latex fluid to a mixing zone of a coagulum reactor. A coagulum zone extends from the mixing zone, preferably progressively increasing in cross-sectional area in the downstream direction from an entry end to a discharge end. The elastomer latex may be either natural or synthetic and the particulate filler comprises, consists essentially of or consists of the material such as described above. The particulate filler is fed to the mixing zone preferably as a continuous, high velocity jet of injected fluid, while the latex fluid is fed at low velocity. The velocity, flow rate and particulate concentration of the particulate filler fluid are sufficient to cause mixture with high shear of the latex fluid and flow turbulence of the mixture within at least an upstream portion of the coagulum zone so as to substantially completely coagulate the elastomer latex with the particulate filler prior to the discharge end. Substantially complete coagulation can occur without the need of acid or salt coagulation agent. As disclosed in U.S. Pat. No. 6,075,084, incorporated herein by reference in its entirety, additional elastomer may be added to the material that emerges from the discharge end of the coagulum reactor. As disclosed in U.S. Pat. No. 6,929,783, incorporated herein by reference in its entirety, the coagulum may then be fed to a dewatering extruder. Other examples of suitable masterbatch processes are disclosed in U.S. Pat. No. 6,929,783 to Chung et al.: US 2012/0264875A1 application of Berriot et al.: U.S. 2003/0088006A1 application of Yanagisawa et al.; and EP 1 834 985 B1 issued to Yamada et al.

Carbon black may be evaluated in a suitable rubber formulation, utilizing natural or synthetic rubber. Suitable amounts of carbon black to be used can be determined by routine experimentation, calculations, by taking into consideration factors such as typical loadings of standard ASTM furnace blacks in comparable manufacturing processes, parameters specific to the techniques and/or equipment employed, presence or absence of other additives, desired properties of the end product, and so forth.

The performance of the carbon black as a reinforcing agent for rubber compounds can be assessed by determining, for example, the performance of a rubber composition utilizing the particles relative to the performance of a comparative rubber composition that is similar in all respects except for the use of a carbon black grade suitable for the given application. In other approaches, values obtained for compositions prepared according to the invention can be compared with values known in the art as associated with desired parameters in a given application.

Suitable tests include green rubber tests, cure tests, and cured rubber tests. Among appropriate green rubber tests, ASTM D4483 sets forth a test method for the ML1+4 Mooney Viscosity test at 100° C. Scorch time is measured according to ASTM D4818.

The curing curve is obtained by Rubber Process Analyzer (RPA2000) at 0.5°, 100 cpm, and 150 C (NR)-160C (SBR) according to ASTM D5289.

Performance characteristics of cured samples can be determined by a series of appropriate tests. Tensile strength, elongation at break, and stress at various strains (e.g. 100% and 300%) are all obtained via ASTM D412 Method A. Dynamic mechanical properties including storage modulus, loss modulus, and tan δ are obtained by strain sweep test at 10 Hz, 60C and various strain amplitudes from 0.1% to 63%. Shore A hardness is measured according to ASTM D2240. Tear strength of die B type cured rubber samples are measured according to ATSM D624.

Undispersed area is calculated by analyzing images obtained by reflection mode optical microscopy for cured rubber compounds of a cut cross-sectional area according to various reported methods. Dispersion can also be represented by the Z value (measured, after reticulation, according to the method described by S. Otto and Al in Kautschuk Gummi Kunststoffe, 58 Jahrgang, NR 7-8/2005, article titled New Reference value for the description of Filler Dispersion with the Dispergrader 1000NT. Standard ISO 11345 sets forth visual methods for the rapid and comparative assessment of the degree of macrodispersion of carbon black and carbon black/silica in rubber.

Abrasion resistance is quantified as an index based on abrasion loss of cured rubber by the Cabot Abrader (Lambourn type). Attractive abrasion resistance results can be indicative of advantageous wear properties. Good hysteresis results can be associated with low rolling resistance (and correspondingly higher fuel economy) for motor vehicle tire applications, reduced heat build-up, tire durability, tread life and casing life, fuel economy features for the motor vehicle and so forth.

Iodine number (12 No.) is determined according to ASTM Test Procedure D1510. STSA (statistical thickness surface area) is determined based on ASTM Test Procedure D-5816 (measured by nitrogen adsorption). OAN is determined based on ASTM D2414. COAN is determined based on ASTM D3493 (e.g., D3493-20).

Unless otherwise specified, all material proportions described as a percent herein are in weight percent.

The present invention will be further clarified by the following examples which are intended to be only exemplary in nature.

### EXAMPLES

For purposes of the present invention and the examples presented herein, the following explanation of some terms is provided.

Equivalence Ratios: The overall equivalence ratio Φ_{O} for a partial oxidation process is the ratio of the molar flow of oxidizer needed for stoichiometric combustion of all the input fuels and feedstocks, divided by the actual oxidizer molar flow. Thus when Φ_{O}>1, the mixture is fuel-rich and when it is <1, it is fuel-lean. Carbon black production preferably occurs when Φ_{O} is substantially fuel rich, typically >1.6.

The equivalence ratio Φ_{P}, for the combustion chamber that produces the hot combusted gas, is defined by the amount of burner fuel and oxidizer delivered. Φ_{P} is typically fuel-lean, taking values of 0.33 to 0.9.

The equivalence ratio, Φ_{I} is the equivalence ratio for the combustion chamber plus any additional fuel or feed introduced in the central pipe illustrated in FIG. 5, but leaving out feed introduced at the throat.

Yield: Yield Y is the mass of solid carbon obtained per total mass of feedstock injected into the carbon black reactor, not including natural gas used for the combustion chamber in FIG. 5, and units are [kg C/kg feedstock]. Y is equal to the total mass rate of solid carbon produced in the reactor, divided by the total mass rate of the feedstock, and this is measured in the examples herein by measuring the input rates of the feedstock, the burner fuel, and all oxidizers, as well as the composition of the tail gas produced.

Carbon Content: Carbon Content [C] is the mass-averaged carbon content of all the carbon black feedstocks introduced into the reactor, in units of [kg C/kg feedstock], and is equal to the total mass rate of carbon atoms coming into the reactor via feedstocks, divided by the total mass rate of the feedstock. This value is computed according to the measured rates of decant oil and ethylene feedstocks, and their measured elemental compositions.

Dimensionless Yield: Dimensionless Yield Y/[C] is the above yield divided by the carbon content. It represents the fraction of the maximum possible yield that was obtained. If Y/[C]=0.5, for example, this means that ½ of the feedstock carbon coming into the reactor was converted into solid carbon. The rest was lost as gas-phase species.

### Toluene Extractables, I₂, STSA, OAN, and COAN

The OAN and COAN are analyzed on dry pellets and follow the ASTM standards identified above. 12 number and STSA are analyzed on dry pellets by the ASTM methods identified above.

### Reactor Configuration and Operation

In the examples, decant oil was used as the first carbon black feedstock (Table 5), and ethylene gas was used as the low-yielding carbon black feedstock or as the gaseous carbon black feedstock.

Utilizing a carbon black furnace process, natural gas and hot air are combined in a combustion chamber to provide a hot combusted gas stream, as shown in FIG. 5. This combusted gas was fuel-lean (oxidizer-rich), with an equivalence ratio Φ_{P} typically between 0.32 and 0.8. The combustion chamber was refractory-lined and its inner diameter given in Table 3.

In some of the examples, a portion of the feedstock, using a central pipe 73, as shown in FIG. 5 was introduced. This pipe was positioned approximately on the centerline of the throat, and horizontally. The pipe had an outer diameter of 5.4 cm. When the feedstock through the pipe was liquid decant oil, a full-cone spray or a pressure spray with six evenly spaced orifice holes perpendicular to the long axis of the central pipe was used.

When the feedstock in the central pipe was the low-yielding carbon black feedstock, ethylene, a gas injector 77 as shown in FIG. 5 was used, with dimensions indicated in the tables of examples. This gas injector (FIGS. 6A, showing one hole 610 of three total holes, evenly spaced radially about the tip) or 6B (coaxial gas injector with one hole 611) was mounted on the end of the central pipe. When no feedstock was injected this way, the central pipe was removed.

Next, the combusted gas from the chamber, along with the feedstock introduced in the center pipe (see FIG. 5), if used, was forced into a contraction so that it entered a narrower throat (76 in FIG. 5). At the throat, the low-yielding carbon black feedstock ethylene was injected using 3 gas injectors spaced evenly around the throat's inner perimeter. The injectors were straight metal tubes, with an inner diameter of approximately 2 cm. These were positioned perpendicular to the direction of flow, as sketched in FIG. 5.

The throat was attached to a refractory-lined reactor chamber. The reactor chamber provided residence time for the feedstock to complete its pyrolysis into carbon black particles. At a distance Lquench downstream of the injection plane shown in FIG. 5, a water spray was used to quench, as is typical for carbon black furnace processes. Downstream of the quench, a filter was used to separate carbon black particles from the tail gas stream. The carbon black at the filter was sampled for I₂ Absorption and Toluene Extractables (S20). The carbon black was then pelletized and dried for measurements of STSA, OAN, and COAN.

The filtered tail gas was sampled, and its composition was measured for each condition and yields determined.

TABLE 3
Dimensions in the reactor shown in FIG. 5

| Dimension | Description | Units | Value |
|---|---|---|---|
| D_{chamber} | Combustion Chamber Diameter | cm | 20.3 |
| Dₜₕᵣₒₐₜ | Throat Diameter | cm | 11.4 |
| D_{reactor} | Reactor Diameter | cm | between 68.6 |
| | | | and 91.4 |
| Lₚᵢₚₑ | As given in Examples | | |
| L_{quench} | As given in Examples | | |

The natural gas fed to the combustion chamber in FIG. 5 had a measured average composition as shown in Table 4 for the examples. Components were measured by gas chromatography.

TABLE 4
Natural gas average composition for the experimental data.

| Component | | Mol % |
|---|---|---|
| Nitrogen | % | 2.97 |
| Oxygen | % | 0.00 |
| Carbon Dioxide | % | 0.06 |
| Methane | % | 92.2 |
| Ethane | % | 4.40 |
| Propane | % | 0.32 |
| Isobutane | % | 0.01 |
| n-Butane | % | 0.01 |
| Isopentane | % | 0.00 |
| n-Pentane | % | 0.00 |
| Hexanes | % | 0.00 |
| Hydrogen | % | 0.00 |
| Ethylene | % | 0.00 |

The ethylene used in the examples was 99% pure ethylene (by weight), and was not analyzed further.

The liquid decant oil in these examples was Feedstock G in Table 2, and had the properties listed there, as well as the properties given in Table 5 below.

TABLE 5
Decant oil feedstock properties.

| Method | Property | Units | Value |
|---|---|---|---|
| ASTM D-4052 | Specific Gravity | None | 1.0978 |
| ASTM D-5291-02 | Carbon Wt. % | % | 90.32 |
| ASTM D-5291-02 | Hydrogen Wt. % | % | .63 |
| IP-336 | Sulfur Wt. % | % | 1.36 |
| ASTM D-3228 | Nitrogen Wt. % | % | 0.19 |
| ASTM D-240 | HHV | MJ/kg | 40.64 |

### Results.

Tables 6-9 present examples of the production of carbon black in the furnace process of FIG. 5. Examples 1-5 and 11-13 show what happens when the low-yielding carbon black feedstock ethylene is used alone in the furnace, either in the throat, in the central pipe, or with staging of some ethylene in the central pipe followed by injection of the remainder in the throat. Examples 6-10 and 14-18 show the benefits of the present invention, by comparison with the ethylene-alone cases. In the present invention, a minority of the total feedstock was the first carbon black feedstock, injected via the central pipe, with the low-yielding carbon black feedstock, ethylene, injected in the throat.

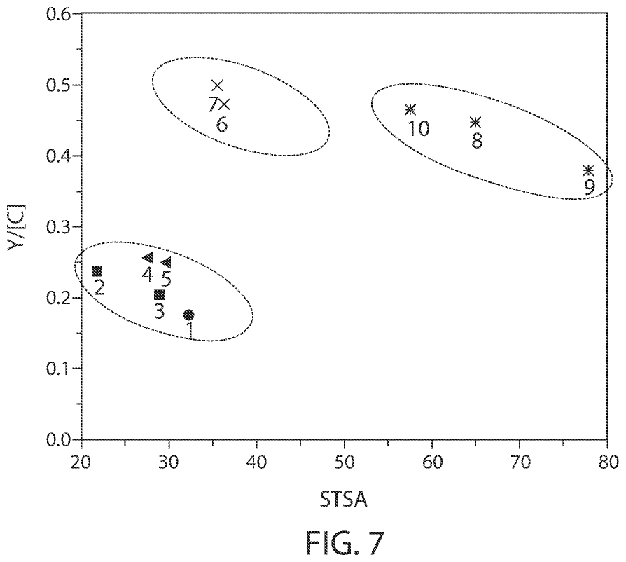

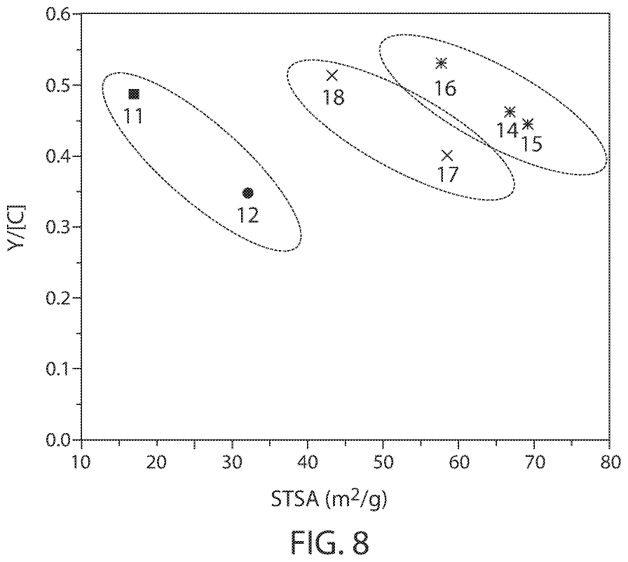

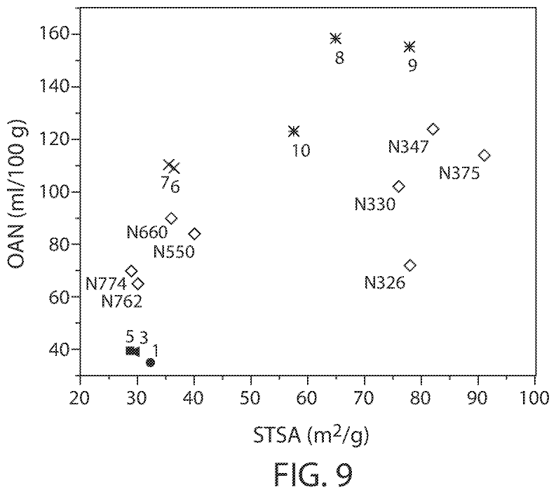

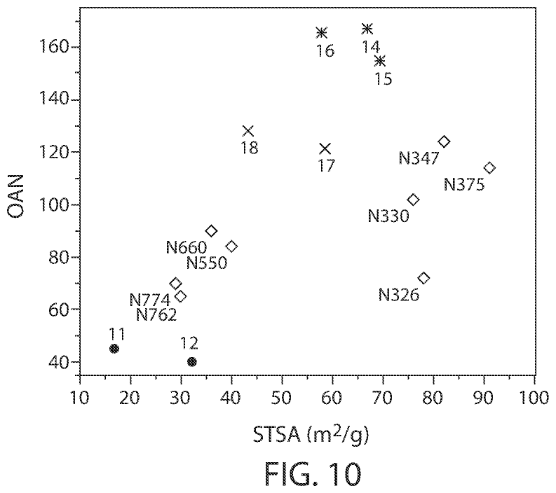

As shown in the results, the use of the low-yielding carbon black feedstock alone produced poor yields for a given surface area (FIGS. 7-8), and a structure capability (as indicated by OAN or COAN) too low to match most ASTM carbon black grades (FIGS. 9-10). Without wishing to be bound by a theory, these results may be attributed, at least in part, to the low aromatic content of the low-yielding carbon black feedstock, relative to first carbon black feedstocks.

Several benefits are obtained with the present invention as shown, at least in part, by the examples herein. First, the dimensionless yield improves greatly when the present invention is practiced, compared to the use of the low-yielding carbon black feedstock alone. Second, the ability to reach high structure greatly increases with the use of the methods of the present invention. Staging of the low-yielding carbon black feedstock by itself (Ex. 4 and Ex. 5) does not achieve these gains.

TABLE 6
Table of examples of carbon black produced with ethylene alone, for Φ_{P} ~0.45

| | | Ex. 1 | Ex. 2 | Ex. 3 | Ex. 4 | Ex. 5 |
|---|---|---|---|---|---|---|
| Air Rate to Burner | Nm³/h | 1613 | 1411 | 1409 | 1410 | 1408 |
| Air Temperature | ° C. | 498 | 499 | 500 | 498 | 499 |
| Natural Gas Rate | Nm³/h | 74 | 64 | 65 | 65 | 65 |
| Natural Gas Temperature | ° C. | 15 | 15 | 15 | 15 | 15 |
| Central Pipe | name | none | Coaxial | Coaxial | Radial | Radial |
| Injector Type | | | | | | |
| Ethylene Rate to | kg/h | 335 | 0 | 0 | 196 | 152 |
| Throat Injectors | | | | | | |
| Ethylene Rate to | kg/h | 0 | 303 | 284 | 108 | 154 |
| Central Pipe | | | | | | |
| Ethylene Temperature | ° C. | 60 | 60 | 60 | 60 | 60 |
| Decant Oil Rate to | kg/h | 0 | 0 | 0 | 0 | 0 |
| Central Pipe | | | | | | |
| Decant Oil Temperature | ° C. | | | | | |
| Fraction of Feedstock | fr | 0.00 | 1.00 | 1.00 | 0.35 | 0.50 |
| to Central Pipe | | | | | | |
| Central Pipe | m | | | 0.76 | 0.48 | 0.48 |
| Location Lₚᵢₚₑ | | | | | | |
| Quench Length L_{quench} | m | 14.3 | 14.3 | 17.4 | 17.4 | 17.4 |
| F_{P} | — | 0.44 | 0.43 | 0.45 | 0.45 | 0.45 |
| F_{O} | — | 2.81 | 2.89 | 2.74 | 2.91 | 2.93 |
| Carbon Yield | kg/kg | 0.149 | 0.203 | 0.174 | 0.219 | 0.213 |
| Mass Average | kg/kg | 0.856 | 0.856 | 0.856 | 0.856 | 0.856 |
| Carbon Content | | | | | | |
| Dimensionless Yield | | 0.175 | 0.237 | 0.203 | 0.256 | 0.249 |
| Surface Area by STSA | m²/g | 32.3 | 21.8 | 28.8 | 27.7 | 29.8 |
| I2 Absorption | g/100 g | 33.6 | 26.9 | 25.6 | 28.4 | 31.4 |
| OAN | ml/100 g | 34.9 | | 39.3 | | 39.1 |
| COAN | ml/100 g | 32.5 | | 35.8 | | |

TABLE 7
Carbon black production in which decant oil is introduced in the central pipe,
with the majority of feedstock introduced at the throat as shown in FIG. 5.

| | | Ex. 6 | Ex. 7 | Ex. 8 | Ex. 9 | Ex. 10 |
|---|---|---|---|---|---|---|
| Air Rate to Burner | Nm³/h | 1409 | 1411 | 1409 | 1408 | 1410 |
| Air Temperature | ° C. | 501 | 500 | 499 | 500 | 497 |
| Natural Gas Rate | Nm³/h | 65 | 65 | 67 | 65 | 64 |
| Natural Gas | ° C. | 15 | 15 | 15 | 15 | 15 |
| Temperature | | | | | | |
| Central Pipe | name | Full Cone | Full Cone | Pressure | Full Cone | Full Cone |
| Injector Type | | Spray | Spray | Spray | Spray | Spray |
| Ethylene Rate to | kg/h | 312 | 328 | 225 | 199 | 228 |
| Throat Injectors | | | | | | |
| Ethylene Rate to | kg/h | 0 | 0 | 0 | 0 | 0 |
| Central Pipe | | | | | | |
| Ethylene Temperature | ° C. | 60 | 60 | 60 | 60 | 60 |
| Decant Oil Rate | kg/h | 98 | 102 | 155 | 136 | 155 |
| to Central Pipe | | | | | | |
| Decant Oil Temperature | ° C. | 154 | 161 | 167 | 160 | 170 |
| Fraction of Feedstock | fr | 0.24 | 0.24 | 0.41 | 0.41 | 0.40 |
| to Central Pipe | | | | | | |
| Central Pipe | m | 0.66 | 0.66 | 0.76 | 0.66 | 0.66 |
| Location Lₚᵢₚₑ | | | | | | |
| Quench Length L_{quench} | m | 17.4 | 17.4 | 17.4 | 17.4 | 17.4 |
| F_{P} | — | 0.44 | 0.44 | 0.46 | 0.44 | 0.44 |
| F_{O} | — | 3.66 | 3.82 | 3.39 | 3.03 | 3.39 |
| Carbon Yield | kg/kg | 0.410 | 0.433 | 0.391 | 0.332 | 0.407 |
| Mass Average | kg/kg | 0.867 | 0.867 | 0.875 | 0.875 | 0.875 |
| Carbon Content | | | | | | |
| Dimensionless Yield | | 0.472 | 0.499 | 0.447 | 0.379 | 0.465 |
| Surface Area by STSA | m²/g | 36.3 | 35.5 | 64.9 | 77.9 | 57.5 |
| I2 Absorption | g/100 g | 39.8 | 40.0 | 66.6 | 81.2 | 63.7 |
| OAN | ml/100 g | 109 | 110 | 158 | 155 | 123 |
| COAN | ml/100 g | 75.3 | | 98.7 | 107.5 | 89.3 |

TABLE 8
Table of examples of carbon black produced with ethylene alone, for Φ_{P}~0.75.

| | | Ex. 11 | Ex. 12 | Ex. 13 |
|---|---|---|---|---|
| Air Rate to Burner | Nm³/h | 1407 | 1408 | 1411 |
| Air Temperature | ° C. | 501 | 501 | 504 |
| Natural Gas Rate | Nm³/h | 111 | 112 | 112 |
| Natural Gas Temperature | ° C. | 15 | 15 | 15 |
| Central Pipe Injector Type | name | none | none | Coaxial |
| Ethylene Rate to Throat Injectors | kg/h | 311 | 276 | 0 |
| Ethylene Rate to Central Pipe | kg/h | 0 | 0 | 311 |
| Ethylene Temperature | ° C. | 60 | 60 | 60 |
| Decant Oil Rate to Central Pipe | kg/h | 0 | 0 | 0 |
| Decant Oil Temperature | ° C. | | | |
| Fraction of Feedstock to Central Pipe | fr | 0.00 | 0.00 | 1.00 |
| Central Pipe Location Lₚᵢₚₑ | m | | | 0.76 |
| Quench Length L_{quench} | m | 14.3 | 14.3 | 14.3 |
| F_{P} | — | 0.76 | 0.77 | 0.76 |
| F_{O} | — | 3.28 | 3.01 | 3.27 |
| Carbon Yield | kg/kg | 0.373 | 0.296 | 0.416 |
| Mass Average Carbon Content | kg/kg | 0.856 | 0.856 | 0.856 |
| Dimensionless Yield | | 0.436 | 0.346 | 0.486 |
| Surface Area by STSA | m²/g | | 32.1 | 16.9 |
| I2 Absorption | g/100 g | 21.8 | 31.1 | 14.6 |
| OAN | ml/100 g | 27 | 40 | 45 |
| COAN | ml/100 g | | 35.7 | |

TABLE 9
Carbon black production in which decant oil is introduced in the central pipe,
with the majority of feedstock introduced at the throat as shown in FIG. 5.

| | | Ex. 14 | Ex. 15 | Ex. 16 | Ex. 17 | Ex. 18 |
|---|---|---|---|---|---|---|
| Air Rate to Burner | Nm³/h | 1410 | 1410 | 1408 | 1411 | 1402 |
| Air Temperature | ° C. | 500 | 500 | 504 | 498 | 496 |
| Natural Gas Rate | Nm³/h | 112 | 112 | 111 | 111 | 111 |
| Natural Gas | ° C. | 15 | 15 | 15 | 15 | 15 |
| Temperature | | | | | | |
| Central Pipe | name | Full Cone | Full Cone | Full Cone | Full Cone | Full Cone |
| Injector Type | | Spray | Spray | Spray | Spray | Spray |
| Ethylene Rate to | kg/h | 174 | 171 | 199 | 218 | 258 |
| Throat Injectors | | | | | | |
| Ethylene Rate to | kg/h | 0 | 0 | 0 | 0 | 0 |
| Central Pipe | | | | | | |
| Ethylene Temperature | ° C. | 60 | 60 | 60 | 60 | 60 |
| Decant Oil Rate | kg/h | 121 | 118 | 140 | 67 | 81 |
| to Central Pipe | | | | | | |
| Decant Oil Temperature | ° C. | 156 | 156 | 162 | 127 | 140 |
| Fraction of Feedstock | fr | 0.41 | 0.41 | 0.41 | 0.23 | 0.24 |
| to Central Pipe | | | | | | |
| Central Pipe | m | 0.66 | 0.66 | 0.66 | 0.66 | 0.66 |
| Location Lₚᵢₚₑ | | | | | | |
| Quench Length L_{quench} | m | 17.4 | 17.4 | 17.4 | 17.4 | 17.4 |
| F_{P} | — | 0.77 | 0.77 | 0.76 | 0.75 | 0.76 |
| F_{O} | — | 3.04 | 2.99 | 3.37 | 3.00 | 3.44 |
| Carbon Yield | kg/kg | 0.404 | 0.388 | 0.464 | 0.347 | 0.445 |
| Mass Average | kg/kg | 0.876 | 0.875 | 0.876 | 0.867 | 0.868 |
| Carbon Content | | | | | | |
| Dimensionless Yield | | 0.462 | 0.444 | 0.530 | 0.400 | 0.513 |
| Surface Area by STSA | m²/g | 66.9 | 69.2 | 57.8 | 58.5 | 43.3 |
| I2 Absorption | g/100 g | 76.9 | 76.6 | 64.3 | 66.5 | 49.7 |
| OAN | ml/100 g | 167 | 155 | 166 | 121 | 128 |
| COAN | ml/100 g | 103.9 | 100.5 | 101.0 | 93.3 | 85.5 |

### Improvement of Yield.

FIG. 7 plots the dimensionless yields obtained from Examples 1-5 and 6-10, against surface area. Number labels on data points refer to example numbers in Tables 6-9. In Examples 1-5, ethylene is the only feedstock used. In Example 1, ethylene is injected in the throat only. In Examples 2 and 3, ethylene is injected using the central pipe only, using the coaxial injector (FIG. 6B). In Examples 4 and 5, a portion of the ethylene feedstock is staged in the central pipe (35 and 50% by mass), with the remainder injected using the throat.

Examples 6-10 in the plot show the effect of the present invention when compared with Examples 1-5. In Examples 6-10, a portion of the feedstock (25 or 40% by mass) was decant oil, injected through the central pipe as indicated in Table 7. The dimensionless yields for these examples were all well above those achieved with the low-yielding carbon black feedstock alone. In particular, compare Examples 1, 3, 4 and 5 in FIG. 7 with Examples 6 and 7. The use of a relatively small amount (25%) of first carbon black feedstock greatly increased the yield obtained, at a given surface area range of 30 to 35 m2/g STSA.

In general, dimensionless yield decreases with increasing surface area in a carbon black furnace process, with other conditions held constant. This is because higher surface areas require higher temperatures, leading to more oxidation and less yield to solid carbon. Thus, a plot of dimensionless yield vs. surface area will give, roughly, a downward trend with increasing surface area. This effect is highlighted with the ovals in FIG. 7. The grouping of carbon blacks made with the present invention (Examples 6-10) is on a trend line whose yield is much higher than those made from ethylene alone (Examples 1-5).

Also note that staging of the ethylene feedstock alone (Examples 4 and 5) does not do very much to improve the yield obtained at a given surface area. The first carbon black feedstock or a high-aromatics-content material appears to be needed in the first stage to produce the effect.

Tables 8 and 9 present a similar set of examples, in which Øp has a higher value. The results are plotted in FIG. 8. Examples 11-12 represent operation without the aspects of the present invention, as ethylene alone was injected either in the throat or in the central pipe: Examples 14-18 show the benefit of the present invention, as a small amount of decant oil was fed via the central pipe. Once again, as in FIG. 7, the present invention greatly increased the yield achievable at a given surface area, and this ranking is maintained independent of @p. Once again, the grouping of carbon blacks made with the present invention (Examples 14-18) was on a trend line whose yield is much higher than those made from ethylene alone (Examples 11-12).

Without being bound by a specific theory, it is hypothesized that the production of seed particles from the first carbon black feedstock introduced in the first stage is either not important, or at least not the only factor in producing the effect of increased yield with the present invention. The value of @; for Examples 6 and 7 was <1.6, suggesting very few carbon black particles were made from the oil in the central pipe: nonetheless, the yield benefit was achieved. Therefore, the effect may at least be partially attributable to the aromatics content of the decant oil.

### Improvement in Structure at Fixed Surface Area.

The second benefit of the present invention was that it provides a substantial increase in structure achievable at a given surface area, as shown in FIG. 9. In this figure, number labels on data points refer to Example numbers in Tables 6-9: “N” labels on open-diamond points refer to ASTM grade requirements for particle structure at a given surface area. All the examples shown here were without the use of alkaline metal additive, so that they represent the maximum achievable structure for the operating configuration described. As can be seen, the aromatics-deficient low-yielding carbon black feedstock alone (Examples 1, 3, and 5) produced carbon black grades of very low structure. The use of the present invention produced much higher maximum structures (Examples 6-10).

It is also noted that staging of the ethylene feedstock alone, as shown in Example 3, did little to improve the structure achievable from the low-yielding carbon black feedstock. Instead, it would appear that the aromatics-rich, or first carbon black feedstock, must be injected in the first stage.

Included in FIG. 9 are points representing typical structures for common, ASTM-listed carbon black grades (open diamonds). This helps illustrate how the present invention can use a feedstock which is incapable of making common carbon black grades, on its own, and provide a process using such a feedstock to make these grades.

Likewise, FIG. 10 shows structure vs. surface area from Tables 8 and 9. Once again, the present invention shows that by injecting an aromatics-rich feedstock upstream of the low-yielding carbon black feedstock, structure and surface area can be obtained as required for common carbon black grades, whereas with the low-yielding carbon black feedstock alone, this is not possible in an ordinary carbon black furnace process.

Examples 19-26 in Tables 10A and 10B, and the figures based on these, illustrate examples where the low-yielding carbon black feedstock was heavy Tire Pyrolysis Oil, or HTPO. HTPO is a recycled oil produced by the pyrolysis of used tire shreds. The oil is then distilled to produce a “heavy” or higher-specific-gravity oil fraction. The HTPO used for these examples had properties shown in Table 11; the conventional feedstock for these examples was Decant Oil, also shown.

TABLE 10A

| Example Number | num | 19 | 20 | 21 | 22 |
|---|---|---|---|---|---|
| Air Rate to Burner | Nm³/h | 2000 | 2000 | 2000 | 2000 |
| Air Temperature | ° C. | 500 | 500 | 500 | 500 |
| Natural Gas Rate | Nm³/h | 160 | 160 | 159 | 159 |
| Natural Gas Temperature | ° C. | 25.0 | 25.0 | 25.0 | 25.0 |
| Reactor Configuration | name | FIG. 5 | FIG. 5 | FIG. 5 | FIG. 5 |
| Central Pipe Injector Type | name | BETE 1/2 | BETE 1/2 | BETE 1/2 | BETE 1/2 |
| Potassium Acetate Solution | g/L | 5 | 5 | 5 | 5 |
| Concentration | | | | | |
| Feedstock Average | ° C. | 150 | 151 | 139 | 144 |
| Temperature | | | | | |
| Total Feedstock Rate to | kg/h | 0 | 0 | 0 | 0 |
| Central Pipe | | | | | |
| Tire Pyrolysis Oil Fraction in | fr | 0.0 | 0.0 | 0.0 | 0.0 |
| Central Pipe Feed | | | | | |
| Total Feedstock Rate to First | kg/h | 449 | 398 | 417 | 492 |
| Throat | | | | | |
| Tire Pyrolysis Oil Fraction in | fr | 1.0 | 1.0 | 0.7 | 0.7 |
| Throat Feed | | | | | |
| Potassium Acetate Solution | kg/h | 3.4 | 3.4 | 3.1 | 3.7 |
| Rate | | | | | |
| Total Feedstock Rate to | kg/h | — | — | — | — |
| Second Throat | | | | | |
| Tire Pyrolysis Oil Fraction in | fr | — | — | — | — |
| Throat Feed | | | | | |
| Potassium Acetate Solution | kg/h | — | — | — | — |
| Rate | | | | | |
| Tire Pyrolysis Oil Fraction in | fr | 1.0 | 1.0 | 0.7 | 0.7 |
| Total Feed | | | | | |
| Central Pipe Location Lpipe | m | 0.71 | 0.71 | 0.71 | 0.71 |
| Quench Length Lquench | m | 7.6 | 4.0 | 4.9 | 4.9 |
| Φₚ | | 0.77 | 0.77 | 0.76 | 0.76 |
| Φ_{O} | | 3.15 | 2.88 | 2.95 | 3.34 |
| Carbon Yield | kg/kg | 0.48 | 0.43 | 0.46 | 0.53 |
| Dimensionless Yield | num | 0.54 | 0.48 | 0.51 | 0.59 |
| Surface Area by STSA | m²/g | 73.9 | 94.1 | 91.6 | 69.4 |
| I2 Absorption | g/100 g | 82.7 | 94.3 | 94.5 | 67.8 |
| OAN | ml/100 g | 65.5 | 64.1 | 82.8 | 73.5 |
| COAN | ml/100 g | 62.7 | 63.0 | 72.0 | 63.5 |

TABLE 10B

| Example Number | num | 23 | 24 | 25 | 26 |
|---|---|---|---|---|---|
| Air Rate to Burner | Nm³/h | 2000 | 2000 | 2000 | 2000 |
| Air Temperature | ° C. | 500 | 500 | 500 | 500 |
| Natural Gas Rate | Nm³/h | 160 | 160 | 160 | 160 |
| Natural Gas Temperature | ° C. | 25.0 | 25.0 | 25.0 | 25.0 |
| Reactor Configuration | name | FIG. 5 | FIG. 5 | FIG. 5 | FIG. 5 |
| Central Pipe Injector Type | name | BETE 1/2 | BETE 1/2 | BETE 1/2 | BETE 1/2 |
| Potassium Acetate Solution | g/L | 5 | 5 | 5 | 5 |
| Concentration | | | | | |
| Feedstock Average | ° C. | 138 | 133 | 140 | 140 |
| Temperature | | | | | |
| Total Feedstock Rate to | kg/h | 147 | 126 | 148 | 125 |
| Central Pipe | | | | | |
| Tire Pyrolysis Oil Fraction in | fr | 0.3 | 0.3 | 1.0 | 1.0 |
| Central Pipe Feed | | | | | |
| Total Feedstock Rate to First | kg/h | 344 | 292 | 344 | 292 |
| Throat | | | | | |
| Tire Pyrolysis Oil Fraction in | fr | 0.7 | 0.7 | 1.0 | 1.0 |
| Throat Feed | | | | | |
| Potassium Acetate Solution | kg/h | 3.6 | 3.0 | 3.5 | 3.1 |
| Rate | | | | | |
| Total Feedstock Rate to | kg/h | — | — | — | — |
| Second Throat | | | | | |
| Tire Pyrolysis Oil Fraction in | fr | — | — | — | — |
| Throat Feed | | | | | |
| Potassium Acetate Solution | kg/h | — | — | — | — |
| Rate | | | | | |
| Tire Pyrolysis Oil Fraction in | fr | 0.7 | 0.7 | 0.7 | 0.7 |
| Total Feed | | | | | |
| Central Pipe Location Lpipe | m | 0.71 | 0.71 | 0.71 | 0.71 |
| Quench Length Lquench | m | 4.9 | 4.9 | 4.9 | 4.9 |
| Φₚ | | 0.77 | 0.77 | 0.77 | 0.77 |
| Φ_{O} | | 3.34 | 2.96 | 3.35 | 2.95 |
| Carbon Yield | kg/kg | 0.53 | 0.46 | 0.53 | 0.46 |
| Dimensionless Yield | num | 0.58 | 0.52 | 0.59 | 0.51 |
| Surface Area by STSA | m²/g | 70.7 | 89.1 | 72.0 | 87.0 |
| I2 Absorption | g/100 g | 72.5 | 92.7 | 71.1 | 91.7 |
| OAN | ml/100 g | 84.1 | 88.1 | 88.7 | 89.3 |
| COAN | ml/100 g | 80.9 | 84.7 | 82.9 | 86.4 |

TABLE 11

| | | | Decant | Heavy | Distiller's |
|---|---|---|---|---|---|
| Method | Property | Units | Oil | TPO | Corn Oil |
| ASTM D-4052 | Specific Gravity | None | 1.07 | 0.96 | 0.92 |
| | Atomic H:C | None | 1.04 | 1.40 | 1.46 |
| | BMCI | None | 137 | 90 | 55* |
| ASTM D-5291-02 | Carbon Wt. % | % | 90.8 | 88.3 | 87.9 |
| ASTM D-5291-02 | Hydrogen Wt. % | % | 7.9 | 10.4 | 10.8 |
| IP-336 | Sulfur Wt. % | % | 0.62 | 0.83 | 0.04 |
| ASTM D-3228 | Nitrogen Wt. % | % | 0.25 | 0.46 | 0.08 |
| ASTM D-240 | HHV | MJ/kg | 40.4 | 43.1 | 39.5 |

*Estimated from average boiling point of 375° C. for corn oils

The reactor configuration for Examples 19-26 is illustrated in FIG. 5. Key dimensions for this configuration are shown in Table 12. In these examples, a portion of the total feedstock, either Decant Oil. or a blend of Decant Oil and HTPO, was sometimes injected into the central pipe 73 using the injector indicated in Table 12. The balance of the total feedstock was injected into the throat 76 in FIG. 5. The throat injectors were a set of 4 small tubes of diameters 0.7 to 1.5 mm, evenly spaced around the circumference of the throat, installed so that they pointed perpendicular to the crossflow. The sizes of the throat injectors were chosen so that the liquid feedstock would penetrate sufficiently into the crossflow of the throat.

TABLE 12

| Dimension | Description | Units | Value |
|---|---|---|---|
| D_{chamber} | Combustion Chamber Diameter | cm | 20.3 |
| Dₜₕᵣₒₐₜ | Throat Diameter | cm | 11.4 |
| D_{reactor} | Reactor Diameter | cm | between 22.9 |
| | | | and 91.4 |
| Lₚᵢₚₑ | As given in Examples | | |
| L_{quench} | As given in Examples | | |

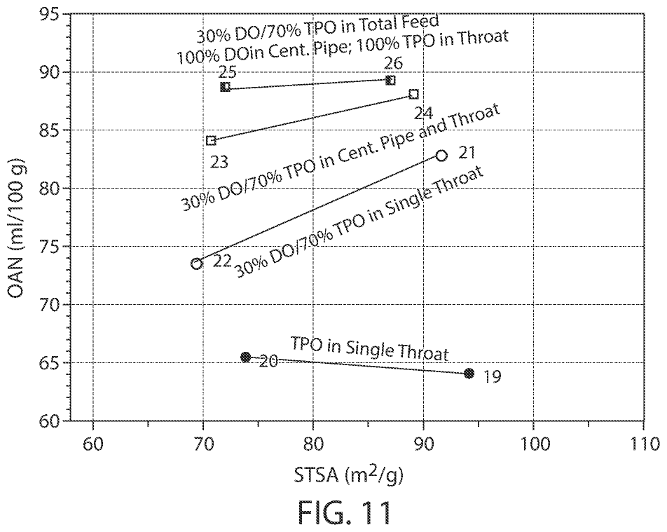

As shown in FIG. 11, when pure HTPO was used, in a single injection location, structure as measured by OAN was low (Ex. 19 and 20). In Ex. 21 and 22, a blend of 30% Decant Oil and 70% HTPO is used in the throat, and structure increases. In Ex. 23 and 24, this same blend was used, except that 30% of the total feedstock amount was injected in the central pipe, with the remainder injected at the throat. In Ex. 25 and 26, the Decant Oil was injected as pure feedstock into the central pipe, while the HTPO was injected as pure feedstock into the throat, such that Decant Oil made up 30% of the total feedstock injected, and HTPO made up 70%. It is this method—in which the first carbon black feedstock was a traditional feedstock, while the low-yielding feedstock was injected downstream—which generated the greatest structure capability.

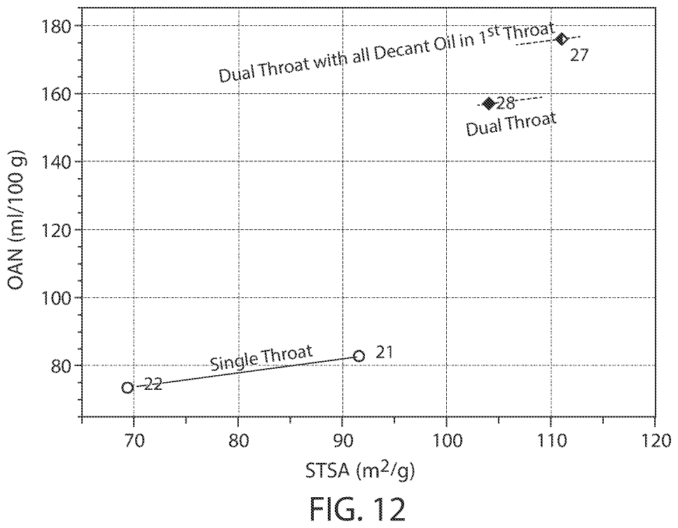

Examples 27-28 in Table 13 illustrate examples in which a configuration such as that given in FIG. 4B was used. Table 14 gives the dimensions for the reactor used in these examples. FIG. 12 plots these examples along with Ex. 21 and 22.

TABLE 13

| Example Number | num | 27 | 28 |
|---|---|---|---|
| Air Rate to Burner | Nm³/h | 2000 | 2000 |
| Air Temperature | ° C. | 500 | 500 |
| Natural Gas Rate | Nm³/h | 160 | 160 |
| Natural Gas Temperature | ° C. | 25.0 | 25.0 |
| Reactor Configuration | name | FIG. 4B | FIG. 4B |
| Central Pipe Injector Type | name | None | None |
| Potassium Acetate Solution | g/L | 1 | 1 |
| Concentration | | | |
| Feedstock Average | ° C. | 139 | 139 |
| Temperature | | | |
| Total Feedstock Rate to First | kg/h | 250 | 250 |
| Throat | | | |
| Tire Pyrolysis Oil Fraction in | fr | 0.5 | 0.7 |
| Throat Feed | | | |
| Potassium Acetate Solution | kg/h | 2 | 2 |
| Rate | | | |
| Total Feedstock Rate to | kg/h | 167 | 168 |
| Second Throat | | | |
| Tire Pyrolysis Oil Fraction in | fr | 1 | 0.7 |
| Throat Feed | | | |
| Potassium Acetate Solution | kg/h | — | — |
| Rate | | | |
| Tire Pyrolysis Oil Fraction in | fr | 0.7 | 0.7 |
| Total Feed | | | |
| Quench Length Lquench | m | 6.7 | 6.7 |
| Φₚ | | 0.77 | 0.77 |
| Φ_{O} | | 2.95 | 2.95 |
| Carbon Yield | kg/kg | 0.435 | 0.444 |
| Dimensionless Yield | num | 0.484 | 0.494 |
| Surface Area by STSA | m²/g | 111 | 104 |
| I2 Absorption | g/100 g | 109 | 115 |
| OAN | ml/100 g | 176 | 157 |

TABLE 14
Numbers of Dimension column refer to FIG. 4B.

| Dimension | Description | Units | Value |
|---|---|---|---|
| D_{chamber} 55 | Combustion Chamber Diameter | cm | 20.3 |
| Dₜₕᵣₒₐₜ 64 | First Throat Diameter | cm | 11.4 |
| D_{section} 58 | Diameter of 1^{st} reactor chamber | cm | 16 |
| L_{section} 66 | Length of 1^{st} reactor chamber | cm | 61 |
| Dₜₕᵣₒₐₜ 65 | Second Throat Diameter | cm | 16 |
| L_{quench} 67 | As given in Examples | | |

All examples in FIG. 12 used an overall feedstock mixture of 30% Decant Oil, and 70% HTPO. When this mixture was injected in a single throat with the configuration in FIG. 5, a relatively low structure results (Ex. 21 and 22). Although this low structure was partially the result of relatively high alkali additive relative to examples 27 and 28, Ex. 21 and 22 would be the lowest structures even if no alkali were used. When the same mixture was injected into two throat locations, a higher structure was obtained (Ex. 28). However, when all the first feedstock, or traditional feedstock, was injected into the first throat, with the low-yielding feedstock used exclusively in the second throat, then a higher structure was achieved at a given surface area (Ex. 27). The dotted-line indications on the data points are guides only, whose slope matches that between Ex. 22 and Ex. 21.

Examples 29-33, in Table 15, illustrate examples when the low-yielding feedstock was a vegetable oil, in this case, Distiller's Com Oil. Table 11 gives the properties of this vegetable oil as used in the experiment. The reactor configuration for these examples is illustrated in FIG. 4B with dimensions as in Table 12.

TABLE 15

| | | Example Number | | | | |
|---|---|---|---|---|---|---|
| | num | 29 | 30 | 31 | 32 | 33 |
| Air Rate to Burner | Nm³/h | 2000 | 2000 | 2000 | 2000 | 2000 |
| Air Temperature | ° C. | 500 | 500 | 500 | 500 | 500 |
| Natural Gas Rate | Nm³/h | 160 | 160 | 160 | 160 | 160 |
| Natural Gas | ° C. | 25 | 25 | 25 | 25 | 25 |
| Temperature | | | | | | |
| Reactor Configuration | name | FIG. 4B | FIG. 4B | FIG. 4B | FIG. 4B | FIG. 4B |
| Central Pipe | name | None | None | None | None | None |
| Injector Type | | | | | | |
| Potassium Acetate | g/L | 1 | 1 | 1 | 1 | 1 |
| Solution Concentration | | | | | | |
| Feedstock Average | ° C. | 160 | 160 | 145 | 166 | 151 |
| Temperature | | | | | | |
| Total Feedstock Rate | kg/h | 360 | 400 | 277 | 244 | 226 |
| to First Throat | | | | | | |
| Dist. Corn Oil | fr | 0.7 | 0.7 | 0.7 | 0.5 | 0.5 |
| Fraction in Throat Feed | | | | | | |
| Potassium Acetate | kg/h | 1.75 | 1.86 | 2.0 | 2.2 | 1.9 |
| Solution Rate | | | | | | |
| Total Feedstock Rate | kg/h | 0 | 0 | 152 | 157 | 151 |
| to Second Throat | | | | | | |
| Dist. Corn Oil | fr | — | — | 0.7 | 1.0 | 1.0 |
| Fraction in Throat Feed | | | | | | |
| Potassium Acetate | kg/h | — | — | — | — | — |
| Solution Rate | | | | | | |
| Dist. Corn Oil | fr | 0.7 | 0.7 | 0.7 | 0.7 | 0.7 |
| Fraction in Total Feed | | | | | | |
| Quench Length | m | 4.4 | 5.7 | 7.3 | 6.7 | 6.7 |
| Lquench | | | | | | |
| Φ_{P} | num | 0.76 | 0.76 | 0.76 | 0.76 | 0.76 |
| Φ_{O} | num | 2.63 | 2.84 | 2.73 | 2.86 | 2.72 |
| Carbon Yield | kg/kg | 0.336 | 0.387 | 0.358 | 0.362 | 0.333 |
| Dimensionless Yield | num | 0.375 | 0.432 | 0.399 | 0.404 | 0.376 |
| Surface Area by STSA | m²/g | 109.5 | 90.5 | 108.3 | 133.1 | 137 |
| I2 Absorption | g/100 g | 112.4 | 98.8 | 113.1 | 136.9 | 137 |
| OAN | ml/100 g | 79.9 | 83.3 | 113.8 | 174.9 | 168.4 |
| COAN | ml/100 g | 71 | 67.40.3 | 95.2 | 120.6 | 120.2 |

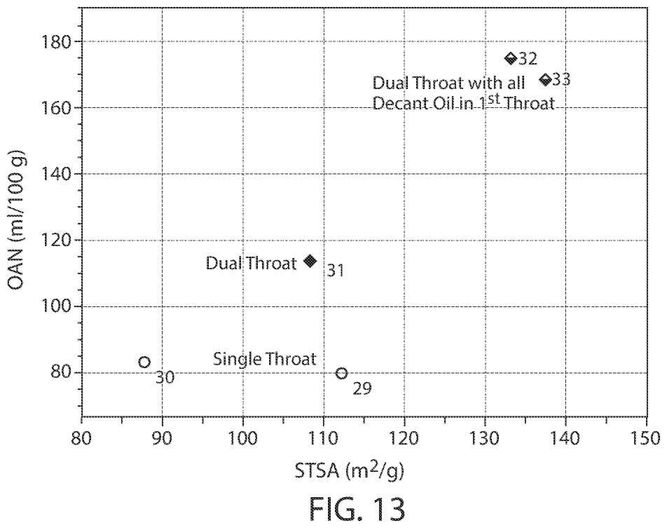

FIG. 13 illustrates the ability of exemplary embodiments to improve the structure capability of the weak feedstock. All these examples used 30% Decant Oil and 70% Distiller's Corn Oil as the carbon black feedstock. In Examples 29 and 30, these two feedstocks were blended directly and injected into a single throat in the reactor. This results in low structure, with OAN less than 90 ml/100 g. When two throats were used, in Example 31, but the feedstocks were blended directly, structure modestly improved but was still low.

However, in an exemplary embodiment where all the Decant Oil went exclusively into the first throat, the structure increased greatly, as shown in Examples 32 and 33. To do this, a blend of 50% Decant Oil and 50% Com Oil was injected in the first throat, while the 100% Corn Oil was injected into the second throat. The overall feedstock usage in these examples was the same as in Examples 29-33: 30% of the total feedstock used was Decant Oil and 70% was Distiller's Corn Oil.

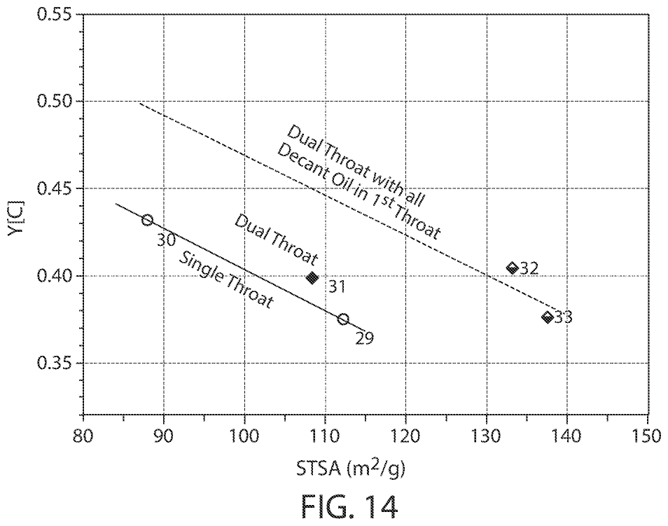

The use of the embodiments provided herein also improved the yield achievable at a given surface area, as shown in FIG. 14. A direct blend of 30% Decant Oil and 70% Corn Oil into a single throat gave low yields (Ex. 29 and 30), while using a dual throat improved this only a little (Ex. 31). However, when all the Decant Oil was injected exclusively into the first throat (50% Decant Oil and 50% Corn Oil in the first throat, 100% Corn Oil in the second throat), then dimensionless yield improved significantly (Ex 32 and 33). The dotted line in FIG. 14 represents the slope of yield with surface area observed with Ex. 29 and 30; this kind of negative slope is typical for furnace carbon black processes.

The present invention includes the following aspects/embodiments/features in any order and/or in any combination:
1. A method for producing a carbon black comprising:
   introducing a heated gas stream into a furnace carbon black reactor:
   combining at least one first carbon black feedstock with said heated gas stream to form a reaction stream wherein the at least one first carbon black feedstock comprises at least 10 wt. % of the total feedstock:
   combining downstream at least one low-yielding carbon black feedstock to said reaction stream present to form the carbon black, wherein the at least one low-yielding carbon black feedstock comprises at least 10 wt. % of the total feedstock; and
   recovering the carbon black in the reaction stream, wherein the first carbon black feedstock is a liquid at room temperature and pressure, and has the following properties:
   a Bureau of Mines Correlation Index (BMCI)≥100,
   an atomic H:C ratio of ≤1.23, and
   a specific gravity >1.02;
and wherein the low-yielding carbon black feedstock has at least one of the following properties:
a Bureau of Mines Correlation Index (BMCI)<100, or
an atomic H:C ratio of >1.23, or
a specific gravity of ≤1.02, or
is a gas at room temperature and pressure.
2. The method of any preceding or following embodiment/feature/aspect, wherein the low-yielding carbon black feedstock is at least one of the following:
a) said Bureau of Mines Correlation Index (BMCI)<95, or
b) said gas at room temperature and pressure, or
c) said atomic H:C ratio of >1.3, or
d) said specific gravity less than or equal to 1.0.
3. The method of any preceding or following embodiment/feature/aspect, wherein the low-yielding carbon lack feedstock is ethylene.
4. The method of any preceding or following embodiment/feature/aspect, wherein the low-yielding carbon black feedstock is natural gas.
5. The method of any preceding or following embodiment/feature/aspect, wherein the low-yielding carbon black feedstock has said specific gravity of less than 1.02.
6. The method of any preceding or following embodiment/feature/aspect, wherein the low-yielding carbon black feedstock is a tire pyrolysis oil, or an oil derived from the distillation or fractionation of tire pyrolysis oil.
7. The method of any preceding or following embodiment/feature/aspect, wherein the low-yielding carbon black feedstock is a feedstock other than a coal tar liquid, an oil-refinery liquid, or an ethylene cracker residue, or a phenol cracker residue.
8. The method of any preceding or following embodiment/feature/aspect, wherein the low-yielding carbon black feedstock is a plastic pyrolysis oil, a high H:C decant oil, a renewable feedstock, a bio-sourced feedstock, or other byproduct of a refining process, or any combination thereof.
9 The method of any preceding or following embodiment/feature/aspect, wherein said bio-sourced feedstock comprises at least one of the following: a vegetable or other plant-derived oil, a bio-sourced ethanol, a plant- or animal-produced wax or resin, an oil rendered from animal fat, an algal oil, an oil rendered from the pyrolysis of sewage sludge or agricultural waste, a byproduct liquid from processing of a biogenic material, a liquid produced by hydrothermal liquefaction of a biomaterial, a crude tall oil, a tall oil rosin, a tall oil pitch, or a tall oil fatty acid, an oil produced from recycled material, an oil derived from the pyrolysis of off-quality, rejected, or end-of-life tires, an oil derived from the pyrolysis of discarded or recycled plastics or rubber products, an oil derived from the pyrolysis of municipal solid waste, or an oil derived from the pyrolysis of biomass, or any combinations thereof.
10. The method of any preceding or following embodiment/feature/aspect, wherein the low-yielding carbon black feedstock ranges from 10-90 wt % of a total feedstock input in said method.
11. The method of any preceding or following embodiment/feature/aspect, wherein the low-yielding carbon black feedstock ranges from 25-90 wt % of a total feedstock input in said method.
12. The method of any preceding or following embodiment/feature/aspect, wherein the furnace carbon black reactor has a combustion chamber and a throat downstream of the combustion chamber and a reaction chamber downstream of the throat and a quench zone downstream of the reaction chamber, and wherein the first carbon black feedstock is injected in a combustion chamber of the furnace carbon black reactor and the low-yielding carbon black feedstock is injected in the throat.
13. The method of any preceding or following embodiment/feature/aspect, wherein the combustion chamber has a diameter and the low-yielding carbon black feedstock is injected at a distance of at least 2× the combustion chamber diameter downstream from where the first carbon black feedstock is injected.
14. The method of any preceding or following embodiment/feature/aspect, wherein said at least one first carbon black feedstock is introduced into said furnace carbon black reactor in at least two separate locations, with one of the separate locations being downstream of the other.
15. The method of any preceding or following embodiment/feature/aspect, wherein said at least one low-yielding carbon black feedstock is introduced into said furnace carbon black reactor in at least two separate locations, with one of the separate locations being downstream of the other.
16. The method of any preceding or following embodiment/feature/aspect, wherein said at least one first carbon black feedstock is a blend that comprises less than 50 wt % of a low-yielding carbon black feedstock based on total weight of said first carbon black feedstock.
17. The method of any preceding or following embodiment/feature/aspect, wherein said at least one first carbon black feedstock comprises 95 wt % to 100 wt % of said first carbon black feedstock based on total weight of said first carbon black feedstock.
18. The method of any preceding or following embodiment/feature/aspect, wherein said at least one low-yielding carbon black feedstock comprises 95 wt % to 100 wt % of said low-yielding carbon black feedstock based on total weight of said first carbon black feedstock.
19. The method of any preceding or following embodiment/feature/aspect, wherein said at least one low-yielding carbon black feedstock is a blend that comprises less than 50 wt % of a first carbon black feedstock based on total weight of said low-yielding carbon black feedstock.
20. The method of any preceding or following embodiment/feature/aspect, wherein said low-yielding carbon black feedstock has said BMCI of <100.
21. The method of any preceding or following embodiment/feature/aspect, wherein said low-yielding carbon black feedstock has said atomic H:C ratio of >1.23.
22. The method of any preceding or following embodiment/feature/aspect, wherein said low-yielding carbon black feedstock is said gas at room temperature and pressure.
23. The method of any preceding or following embodiment/feature/aspect, wherein said carbon black recovered is a N110, N121, N220, N231, N234, N299, N326, N330, N339, N347, N351, N358, N375, N539, N550, N650, N660, N683, N762, N765, N774, N787, or N990 grade carbon black.
24. The method of any preceding or following embodiment/feature/aspect, wherein the at least one low-yielding carbon black feedstock is pyrolysis oil and is present in an amount of from 10 wt % to 90 wt %, based on said total feedstock, and the at least one first carbon black feedstock is present in an amount of from 10 wt % to 90 wt % based on said total feedstock.
25. The method of any preceding or following embodiment/feature/aspect, wherein the at least one low-yielding carbon black feedstock is ethylene or natural gas or both and is present in an amount of from 30 wt % to 90 wt %, based on said total feedstock, and the at least one first carbon black feedstock is present in an amount of from 10 wt % to 70 wt % based on said total feedstock.
26. The method of any preceding or following embodiment/feature/aspect, wherein the at least one low-yielding carbon black feedstock is bio-based feedstock and is present in an amount of from 10 wt % to 90 wt %, based on said total feedstock, and the at least one first carbon black feedstock is present in an amount of from 10 wt % to 90 wt % based on said total feedstock.
27. A method for producing a carbon black comprising:
   introducing a heated gas stream into a furnace carbon black reactor:
   combining at least one first carbon black feedstock with said heated gas stream to form a reaction stream wherein the at least one first carbon black feedstock comprises at least 10 wt. % of the total feedstock:
   combining downstream at least one low-yielding carbon black feedstock to said reaction stream present to form the carbon black, wherein the at least one low-yielding carbon black feedstock comprises at least 10 wt. % of the total feedstock; and
   recovering the carbon black in the reaction stream, wherein the first carbon black feedstock is a liquid at room temperature and pressure, and has the following properties:
   a Bureau of Mines Correlation Index (BMCI)≥100,
   an atomic H:C ratio of ≤1.23, and
   a specific gravity >1.02:
and wherein the low-yielding carbon black feedstock has at least one of the following properties:
a Bureau of Mines Correlation Index (BMCI)<100, or
an atomic H:C ratio of >1.23, or
   a specific gravity of ≤1.02, or
is a gas at room temperature and pressure, and
   wherein the at least one low-yielding carbon black feedstock is pyrolysis oil and is present in an amount of from 10 wt % to 90 wt %, based on said total feedstock, and the at least one first carbon black feedstock is present in an amount of from 10 wt % to 90 wt % based on said total feedstock.
28. A method for producing a carbon black comprising:
   introducing a heated gas stream into a furnace carbon black reactor:
   combining at least one first carbon black feedstock with said heated gas stream to form a reaction stream wherein the at least one first carbon black feedstock comprises at least 10 wt. % of the total feedstock:
   combining downstream at least one low-yielding carbon black feedstock to said reaction stream present to form the carbon black, wherein the at least one low-yielding carbon black feedstock comprises at least 10 wt. % of the total feedstock; and
   recovering the carbon black in the reaction stream, wherein the first carbon black feedstock is a liquid at room temperature and pressure, and has the following properties:
   a Bureau of Mines Correlation Index (BMCI)≥100,
   an atomic H:C ratio of ≤1.23, and
   a specific gravity >1.02;
and wherein the low-yielding carbon black feedstock has at least one of the following properties:
a Bureau of Mines Correlation Index (BMCI)<100, or
an atomic H:C ratio of >1.23, or
   a specific gravity of ≤1.02, or
is a gas at room temperature and pressure, and
   wherein the at least one low-yielding carbon black feedstock is ethylene or natural gas or both and is present in an amount of from 30 wt % to 90 wt %, based on said total feedstock, and the at least one first carbon black feedstock is present in an amount of from 10 wt % to 70 wt % based on said total feedstock.
29. A method for producing a carbon black comprising:
   introducing a heated gas stream into a furnace carbon black reactor:
   combining at least one first carbon black feedstock with said heated gas stream to form a reaction stream wherein the at least one first carbon black feedstock comprises at least 10 wt. % of the total feedstock;
   combining downstream at least one low-yielding carbon black feedstock to said reaction stream present to form the carbon black, wherein the at least one low-yielding carbon black feedstock comprises at least 10 wt. % of the total feedstock; and
   recovering the carbon black in the reaction stream, wherein the first carbon black feedstock is a liquid at room temperature and pressure, and has the following properties:
   a Bureau of Mines Correlation Index (BMCI)≥100,
   an atomic H:C ratio of ≤1.23, and
   a specific gravity >1.02;
and wherein the low-yielding carbon black feedstock has at least one of the following properties:
a Bureau of Mines Correlation Index (BMCI)<100, or
an atomic H:C ratio of >1.23, or
   a specific gravity of ≤1.02, or
is a gas at room temperature and pressure, and
   wherein the at least one low-yielding carbon black feedstock is bio-based feedstock and is present in an amount of from 10 wt % to 90 wt %, based on said total feedstock, and the at least one first carbon black feedstock is present in an amount of from 10 wt % to 90 wt % based on said total feedstock.
30. A method for producing a carbon black comprising:
   introducing a heated gas stream into a furnace carbon black reactor:
   combining a blend comprising at least one first carbon black feedstock and at least one low-yielding carbon black feedstock with said heated gas stream to form a reaction stream to form the carbon black, wherein the at least one low-yielding carbon black feedstock comprises at least 10 wt. % of the total feedstock and the at least one first carbon black feedstock comprises at least 10 wt. % of the total feedstock; and
   recovering the carbon black in the reaction stream, wherein the first carbon black feedstock is a liquid at room temperature and pressure, and has the following properties:
   a Bureau of Mines Correlation Index (BMCI)≥100,
   an atomic H:C ratio of ≤1.23, and
   a specific gravity >1.02:
and wherein the low-yielding carbon black feedstock has at least one of the following properties:
a Bureau of Mines Correlation Index (BMCI)<100, or
an atomic H:C ratio of >1.23, or
   a specific gravity of ≤1.02, or
      is a gas at room temperature and pressure, and
      wherein the at least one low-yielding carbon black feedstock is pyrolysis oil and is present in an amount of from 10 wt % to 90 wt %, based on said total feedstock, and the at least one first carbon black feedstock is present in an amount of from 10 wt % to 90 wt % based on said total feedstock.
31. Carbon black made from any method of any preceding or following embodiment/feature/aspect,

The present invention can include any combination of these various features or embodiments above and/or below as set forth in any sentences and/or paragraphs herein. Any combination of disclosed features herein is considered part of the present invention and no limitation is intended with respect to combinable features.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A method for producing a carbon black comprising:
introducing a heated gas stream into a furnace carbon black reactor;
combining at least one first carbon black feedstock with said heated gas stream to form a reaction stream wherein the at least one first carbon black feedstock comprises at least 10 wt. % of the total feedstock;
combining downstream at least one low-yielding carbon black feedstock to said reaction stream present to form the carbon black, wherein the at least one low-yielding carbon black feedstock comprises at least 10 wt. % of the total feedstock; and
recovering the carbon black in the reaction stream, wherein the first carbon black feedstock is a liquid at room temperature and pressure, and has the following properties:
a Bureau of Mines Correlation Index (BMCI)≥100,
an atomic H:C ratio of ≤1.23, and
a specific gravity >1.02;
and wherein the low-yielding carbon black feedstock has at least one of the following properties:
a Bureau of Mines Correlation Index (BMCI)<100, or
an atomic H:C ratio of >1.23, or
a specific gravity of ≤1.02, or
is a gas at room temperature and pressure, and
wherein the at least one low-yielding carbon black feedstock is pyrolysis oil and is present in an amount of from 10 wt % to 90 wt %, based on said total feedstock, and the at least one first carbon black feedstock is present in an amount of from 10 wt % to 90 wt % based on said total feedstock.

2. A method for producing a carbon black comprising:
introducing a heated gas stream into a furnace carbon black reactor;
combining at least one first carbon black feedstock with said heated gas stream to form a reaction stream wherein the at least one first carbon black feedstock comprises at least 10 wt. % of the total feedstock;
combining downstream at least one low-yielding carbon black feedstock to said reaction stream present to form the carbon black, wherein the at least one low-yielding carbon black feedstock comprises at least 10 wt. % of the total feedstock; and
recovering the carbon black in the reaction stream, wherein the first carbon black feedstock is a liquid at room temperature and pressure, and has the following properties:
a Bureau of Mines Correlation Index (BMCI)≥100,
an atomic H:C ratio of ≤1.23, and
a specific gravity >1.02;
and wherein the low-yielding carbon black feedstock has at least one of the following properties:
a Bureau of Mines Correlation Index (BMCI)<100, or
an atomic H:C ratio of >1.23, or
a specific gravity of ≤1.02, or
is a gas at room temperature and pressure, and
wherein the at least one low-yielding carbon black feedstock is ethylene or natural gas or both and is present in an amount of from 30 wt % to 90 wt %, based on said total feedstock, and the at least one first carbon black feedstock is present in an amount of from 10 wt % to 70 wt % based on said total feedstock.

3. A method for producing a carbon black comprising:
introducing a heated gas stream into a furnace carbon black reactor;
combining at least one first carbon black feedstock with said heated gas stream to form a reaction stream wherein the at least one first carbon black feedstock comprises at least 10 wt. % of the total feedstock;
combining downstream at least one low-yielding carbon black feedstock to said reaction stream present to form the carbon black, wherein the at least one low-yielding carbon black feedstock comprises at least 10 wt. % of the total feedstock; and
recovering the carbon black in the reaction stream, wherein the first carbon black feedstock is a liquid at room temperature and pressure, and has the following properties:
a Bureau of Mines Correlation Index (BMCI)≥100,
an atomic H:C ratio of ≤1.23, and
a specific gravity >1.02;
and wherein the low-yielding carbon black feedstock has at least one of the following properties:
a Bureau of Mines Correlation Index (BMCI)<100, or
an atomic H:C ratio of >1.23, or
a specific gravity of ≤1.02, or
is a gas at room temperature and pressure, and
wherein the at least one low-yielding carbon black feedstock is bio-based feedstock and is present in an amount of from 10 wt % to 90 wt %, based on said total feedstock, and the at least one first carbon black feedstock is present in an amount of from 10 wt % to 90 wt % based on said total feedstock.

4. A method for producing a carbon black comprising:
introducing a heated gas stream into a furnace carbon black reactor;
combining a blend comprising at least one first carbon black feedstock and at least one low-yielding carbon black feedstock with said heated gas stream to form a reaction stream to form the carbon black, wherein the at least one low-yielding carbon black feedstock comprises at least 10 wt. % of the total feedstock and the at least one first carbon black feedstock comprises at least 10 wt. % of the total feedstock; and
recovering the carbon black in the reaction stream, wherein the first carbon black feedstock is a liquid at room temperature and pressure, and has the following properties:
a Bureau of Mines Correlation Index (BMCI)≥100,
an atomic H:C ratio of ≤1.23, and
a specific gravity >1.02;
and wherein the low-yielding carbon black feedstock has at least one of the following properties:
a Bureau of Mines Correlation Index (BMCI)<100, or
an atomic H:C ratio of >1.23, or
a specific gravity of ≤1.02, or
is a gas at room temperature and pressure, and
wherein the at least one low-yielding carbon black feedstock is pyrolysis oil and is present in an amount of from 10 wt % to 90 wt %, based on said total feedstock, and the at least one first carbon black feedstock is present in an amount of from 10 wt % to 90 wt % based on said total feedstock.

5. (canceled)

6. (canceled)

7. The method of claim 3, wherein said bio-based feedstock comprises at least one of the following: a vegetable or other plant-derived oil, a bio-sourced ethanol, a plant- or animal-produced wax or resin, an oil rendered from animal fat, an algal oil, an oil rendered from the pyrolysis of sewage sludge or agricultural waste, a byproduct liquid from processing of a biogenic material, a liquid produced by hydrothermal liquefaction of a biomaterial, a crude tall oil, a tall oil rosin, a tall oil pitch, or a tall oil fatty acid, an oil produced from recycled material, an oil derived from the pyrolysis of off-quality, rejected, or end-of-life tires, an oil derived from the pyrolysis of discarded or recycled plastics or rubber products, an oil derived from the pyrolysis of municipal solid waste, or an oil derived from the pyrolysis of biomass, or any combinations thereof.

8. The method of claim 1, wherein the at least first carbon black feedstock comprises one or more of decant oil, slurry oil, coal tar, coal tar derivative, ethylene cracker residue, or phenol cracker residue.

9. The method of claim 1, wherein the first carbon black feedstock comprises a fraction obtained from distillation of tire pyrolysis oil.

10. (canceled)

11. The method of claim 1, wherein the furnace carbon black reactor has a combustion chamber and a throat downstream of the combustion chamber and a reaction chamber downstream of the throat and a quench zone downstream of the reaction chamber, and wherein the first carbon black feedstock is injected in a combustion chamber of the furnace carbon black reactor and the low-yielding carbon black feedstock is injected in the throat.

12. The method of claim 11, wherein the combustion chamber has a diameter and the low-yielding carbon black feedstock is injected at a distance of at least 2× the combustion chamber diameter downstream from where the first carbon black feedstock is injected.

13. The method of claim 1, wherein the furnace carbon black reactor has a combustion chamber and a throat downstream of the combustion chamber and a reaction chamber downstream of the throat and a quench zone downstream of the reaction chamber, and wherein the first carbon black feedstock is injected in said throat and the low-yielding carbon black feedstock is injected after said throat.

14. The method of claim 13, wherein the furnace carbon black reactor comprises a second throat downstream of said combustion chamber and before said quench zone, and said low-yielding carbon black feedstock is injected in said second throat.

15. The method of claim 1, wherein said at least one first carbon black feedstock is introduced into said furnace carbon black reactor in at least one location upstream from a location where the at least one low-yielding carbon black feedstock is injected and at least one separate location downstream of the said at least one low-yielding carbon black feedstock location.

16. The method of claim 15, wherein the amount of the first carbon black feedstock introduced prior to the location where the at least one low-yielding feedstock is injected is greater than 50% of the total amount of the first carbon black feedstock.

17. The method of claim 1, wherein said at least one low-yielding carbon black feedstock is introduced into said furnace carbon black reactor in at least two separate locations, with one of the separate locations being downstream of the other.

18. The method of claim 1, wherein said at least one first carbon black feedstock is a blend that comprises less than 50 wt % of a non-high yielding carbon black feedstock based on total weight of said first carbon black feedstock.

19. The method of claim 1, wherein said at least one first carbon black feedstock comprises 95 wt % to 100 wt % of a high yielding carbon black feedstock based on total weight of said first carbon black feedstock.

20. The method of claim 1, wherein said at least one low-yielding carbon black feedstock comprises 95 wt % to 100 wt % of a non-high yielding carbon black feedstock based on total weight of said low-yielding carbon black feedstock.

21. The method of claim 1, wherein said at least one low-yielding carbon black feedstock is a blend that comprises less than 50 wt % of a high yielding carbon black feedstock based on total weight of said low-yielding carbon black feedstock.

22. The method of claim 1, wherein said low-yielding carbon black feedstock has said BMCI of <100.

23. (canceled)

24. The method of claim 1, wherein said low-yielding carbon black feedstock is said gas at room temperature and pressure.

25. (canceled)
